(19) United States
(12) Patent Application Publication
(10) Pub. No.: US 2025/0146983 A1
(43) Pub. Date: May 8, 2025

(54) DEVICE FOR A GAS CHROMATOGRAPH, IN PARTICULAR A TEMPERATURE GRADIENT GAS CHROMATOGRAPH, AND GAS CHROMATOGRAPH HAVING SUCH A DEVICE

(71) Applicant: Peter Boeker, Bonn (DE)

(72) Inventor: Peter Boeker, Bonn (DE)

(21) Appl. No.: 18/038,225

(22) PCT Filed: Nov. 18, 2021
(86) PCT No.: PCT/EP2021/082206

§ 371 Date: Apr. 15, 2024

(30) Foreign Application Priority Data
Nov. 24, 2020 (DE) 10 2020 131 021.8

(51) Int. Cl. G01N 30/30; G01N 30/02; G01N 30/60; G01N 30/88

(52) U.S. Cl. CPC G01N 30/30; G01N 30/6078; G01N 30/88; G01N 2030/025; G01N 2030/3015; G01N 2030/8881

(57) ABSTRACT

A device for a gas chromograph includes a module and a separating capillary, which is arranged in the module. The separating capillary may be heated and is arrangeable in a controllable fluid flow field of a fluid. A material or a material mixture to be analyzed by the gas chromatograph, in particular a temperature gradient gas chromatograph, can be applied to the separating capillary. Furthermore, the device includes a generating device that generates a fluid flow of the fluid. The generating device is used for influencing the temperature of the separating capillary, and an influencing device for influencing the fluid flow of the fluid. A receptacle device for accommodating the module is provided. The module is insertable into the receptacle device and is removable from the receptacle device.

### TECHNICAL FIELD

This application relates to a device for a gas chromatograph and more particularly to a device for a temperature gradient gas chromatograph and a gas chromatograph having such a device.

### BACKGROUND

The fundamental method of gas chromatography is known from the prior art. The method represents a method for separating mixtures of volatile materials into the underlying materials of the mixture and is applied in the context of a chemical analysis of material mixtures.

In classic, isothermal gas chromatography, a separating capillary (often also designated as a capillary or as a separating column) is temperature controlled in an air bath furnace. A coating can be applied to an inner surface of the separating capillary. A material mixture to be analyzed and a carrier gas are submitted at an inlet of the separating capillary. A material-specific phase equilibrium between a component of the material mixture to be analyzed, which is in the carrier gas, and a component of the material mixture which is adsorbed or absorbed on the coating of the separating capillary, results as a function of the temperature in the separating capillary. The temperature of the separating capillary and the temperature-dependent phase equilibrium of a material predominantly determine the transport speed of the materials contained in the material mixture in the separating capillary. It is thus possible that different materials of a material mixture can be transported at different speeds from the inlet of the separating capillary to its outlet. For example, a strong interaction between a material of the material to be analyzed and the coating of the separating capillary results in a slow transport of the material along the separating capillary. A weak interaction between a material of the material mixture to be analyzed and the coating of the separating capillary results in a rapid transport of the material along the separating capillary. A detection device, for example a mass spectrometer, can be connected at the outlet of the separating capillary, using which the materials of the material mixture can be successively detected.

In one refinement of isothermal gas chromatography, namely temperature-programmed gas chromatography, the temperature of the air bath furnace can be controlled during a gas-chromatography analysis, for example increased over time, so that the respective materials of the material mixture can be transported due to the material-specific temperature-dependent phase equilibria at different temperature levels along the separating capillary. A spatial and chronological separation of the materials thus results.

The above-described air bath furnace concept of gas chromatography achieves a high level of temperature stability and temperature homogeneity of the separating capillary due to intensive turbulent thorough mixing of the air in the air bath furnace. Furthermore, due to the size and the easy accessibility of the air bath furnace, the air bath furnace permits a simple exchange of the separating capillary arranged therein. However, the thermal inertia of the system has proven to be a disadvantage, in particular also during its cooling, which negatively affects carrying out faster measurements.

With the goal of reducing the thermal inertia of gas chromatographs, electrically heated gas chromatographs have been developed, in which the introduced thermal energy is to be concentrated on the separating capillary or immediate surroundings of the separating capillary. For the concentration of the heat, for example, a separating capillary made of metal can be directly electrically heated or a nonconductive polyimide-coated quartz glass separating capillary can be inserted into a heatable envelope capillary and heated. In these cases, the separating capillary is not arranged in an air bath furnace, so that in the case of electrical heating of the separating capillary, the temperature-homogenizing influence of the air thorough mixing does not take place. A temperature of the separating capillary thus primarily results from the supplied electrical energy, which dissipates in the separating capillary in thermal energy, and the discharged energy. The discharged energy essentially relates to emitted radiation, which increases in particular at higher temperatures, and convection of the air surrounding the separating capillary. With natural convection, air heated in the surroundings of the separating capillary can rise and generate a continuous cooling flow. With forced convection, i.e., with forced incident flow, the cooling effect can be significantly increased and can be controllable.

One concept of gas chromatography, which makes the effect of the forced incident flow usable, is flow field temperature gradient gas chromatography. Flow field temperature gradient gas chromatography is included in temperature gradient gas chromatography. Temperature gradient gas chromatography is based on the observation that materials have a temperature characteristic, below which no noticeable material transport takes place in a separating capillary. In temperature gradient gas chromatography, the separating capillary has a negative temperature gradient from an inlet to an outlet of the separating capillary, so that materials of a material mixture, after being supplied in the separating capillary in a first step of the gas chromatography analysis, collect at specific points of the separating capillary at which the abovementioned characteristic temperature for a noticeable material transport is not reached. Due to a homogeneous temperature increase of the separating capillary carried out in a further step of the gas chromatography analysis, the materials of the material mixture are transported through the separating capillary. The materials thus successively reach the outlet of the separating capillary, at which the materials can be detected by a detection device.

The above-described temperature gradient gas chromatography is known from the prior art. Thus, DE 10 2014 004 286 B3 describes a method, a device, and the use of a method for gas chromatography separation and determination of volatile materials in a carrier gas via a chromatographic separating capillary, where the separating capillary and/or an envelope capillary surrounding the separating capillary is electrically conductive. Furthermore, the separating capillary and/or the envelope capillary surrounding the separating capillary is/are heated using current in the form of a resistance heater and cooled by a forced convective flow using a fluid in the form of a gradient flow field so that a continuous temperature gradient results over the length of the separating capillary. The document describes that a thermal gradient field does not have to be generated around the separating capillary, which first indirectly warms or heats the separating capillary to the desired temperatures. Rather, the temperature gradient occurs as a result of the gradually changing heat balance, so that an exact and rapidly operating gas chromatography system can be constructed.

A device according to DE 10 2014 004 286 B3 has a hollow cylindrical carrier, which carries the separating capillary and can have a diameter of approximately 20 cm, for example. The separating capillary is arranged helically in the hollow cylindrical carrier. To reach a length of the separating capillary which is suitable for a gas chromatography analysis, multiple turns of the helical separating capillary are arranged one over another in the hollow cylindrical carrier, for example over a height of approximately 12 cm. The volume of the device of DE 10 2014 004 286 B3 is therefore comparatively large.

Because of the described construction, the convective flow for cooling the separating capillary enters at one end face of the hollow cylindrical carrier and exits at a lateral surface of the hollow cylindrical carrier. Since the flow cannot be disturbed (that is to say the flow in particular cannot be subjected to turbulence and/or accumulation), sufficient distances to other components which are arranged on the disclosed device are required, which further enlarges the required occupied space.

It is hardly possible to reduce the size of the carrier of the separating capillary for two reasons:
A reduction of the diameter of the carrier of the separating capillary in the device disclosed in DE 10 2014 004 286 B3 results in a proportional reduction of the length of a turn. To obtain a length of the separating capillary which is sufficient for a gas chromatography separation of a material, multiple turns have to be provided proportionally in the event of a reduction of the diameter of the carrier. The height and thus the volume of the carrier of the separating capillary are thus enlarged again.
The separating capillary is normally exchanged in the device disclosed in DE 10 2014 004 286 B3 by pulling out and inserting the separating capillary in the metallic envelope capillary. In particular, the insertion only succeeds if the radius of the envelope capillary is not excessively small, since otherwise high friction forces are present. Reducing the radius below a value of approximately 20 cm is therefore unfavorable.

The construction of the device according to DE 10 2014 004 286 B3 is very suitable for use in laboratories, since the structural size and the weight are adapted very well to other components of measuring devices, such as a sample delivery device arranged in an upper part of the device and/or a detection device, usually a mass spectrometer.

In many areas of use, there is a desire for compact and fast gas chromatographs, which can be maintained easily and in which the separating capillary can be exchanged easily and safe from damage. Such gas chromatographs are required, for example, for mobile gas chromatography analyses, for example in emergency vehicles of the fire department and/or the police. In industry, compact and fast gas chromatographs, which are particularly robust and have to be protected from environmental influences, are required for monitoring processes. Compact and fast gas chromatographs which are required for monitoring processes are also referred to as process gas chromatographs.

When a temperature gradient gas chromatograph is used in monitoring industrial processes (thus a process temperature gradient gas chromatograph), various components of the process temperature gradient gas chromatograph and/or the separating capillary have to be removable for maintenance work. The possibility of integrating a temperature gradient gas chromatograph in existing arrangements of sample delivery devices and detection devices is a further important requirement in large-scale technical use.

The device according to DE 10 2014 004 286 B3 has several disadvantages for the use as a process gas chromatograph or as a mobile gas chromatograph.

A complete housing, which is required upon use as a process gas chromatograph, thus cannot be easily unified with the functional principle of the disclosed temperature gradient gas chromatograph. A housing can be necessary for explosion protection, for example. Furthermore, there are high demands with respect to the supply and the discharge of the convective flow for generating the flow field. It is thus necessary to supply the convective flow sufficiently cool into the hollow cylindrical carrier of the separating capillary. In addition, the heated flow arising on the outside of the carrier of the separating capillary has to be able to be discharged in a controlled manner. Therefore, an extraction device and a heat exchanger can be necessary with a complete housing, in order to ensure the functionality of the disclosed temperature gradient gas chromatograph.

Exchanging the separating capillary is also made more difficult by a housing. Manually handling the sensitive separating capillary by an operator requires sufficient space. A housing therefore has to be constructed as very voluminous. However, this is disadvantageous upon the use in the context of process monitoring, since often little space is available in existing facilities.

In mobile gas chromatographs, handling by less trained operators also has to be possible. Therefore, exchanging a separating capillary has particular importance. A compact construction is additionally required with mobile gas chromatographs. The construction according to DE 10 2014 004 286 B3 is therefore less suitable for meeting all abovementioned demands.

### SUMMARY OF THE INVENTION

The system described herein provides a device for a gas chromatograph, in particular a temperature gradient gas chromatograph, and a gas chromatograph having such a device, where the device:
allows a reduction of the structural size while maintaining the functionality of the gas chromatography, in particular the temperature gradient gas chromatography;
allows a capillary length up to approximately 6 m length, in spite of compact structural form;
allows a spatially compact supply and/or discharge of the flow of the fluid; and
allows a simple exchange of the separating capillary and very good accessibility of the separating capillary.

The device according to the system described herein for a gas chromatograph, in particular a temperature gradient gas chromatograph, includes a module in which a separating capillary is arranged. The separating capillary is heatable and is arrangeable or arranged in a controllable fluid flow field. In addition, a material to be analyzed by the gas chromatograph, in particular the temperature gradient gas chromatograph, can be applied to the separating capillary. The device according to the system described herein also includes at least one generating device for generating a fluid flow of a fluid, where the generating device is used for influencing the temperature of the separating capillary. In addition, the device according to the system described herein includes an influencing device for influencing the fluid flow. In the device according to the system described herein, at least one receptacle device for accommodating the module is provided, where the module is insertable into the receptacle device and removable from the receptacle device.

As described herein, a module is an optionally exchangeable unit of the device according to the system described herein, which contains a functionally closed functional unit. A functionally closed functional unit as described herein is a unit of the device which executes one or more specific functions of the device and is only used to execute the specific functions. A module can have any suitable shape and design. A module can be designed as openly accessible, for example, in that the outer form is defined, for example, by a framework, an at least partially open housing, or even by the closed functional unit itself contained in the module. For the module, which includes a functionally closed functional unit of a device, the property of the exchangeability of the module with a further module having a technically equivalent functionally closed functional unit is useful.

According to the system described herein, for example, a first functionally closed functional unit, which is contained in the module, includes the separating capillary. The separating capillary includes, for example, a heatable, thin-walled tube having a first end and a second end, where the first end and the second end delimit the separating capillary. The separating capillary has a longitudinal axis between the first end and the second end. The longitudinal axis is formed as a mathematically smooth function. In other words, the separating capillary does not have any kinks or any abrupt local curvature. The separating capillary is preferably formed from quartz glass. However, the separating capillary can also be formed from any other material suitable for the system described herein. In this respect, in addition to glasses, ceramics or in particular metals or metal alloys can be used as a material for the separating capillary. For example, the separating capillary may include an inner coating. The separating capillary is electrically heatable, in particular resistively and/or inductively heatable. If the separating capillary is not produced from a resistively and/or inductively heatable material, the first functionally closed functional unit of the module then includes, for example, an electrically heatable envelope capillary, which surrounds the separating capillary. The envelope capillary can be produced from a ceramic or a metal or a metal alloy which is sufficiently rapidly resistively and/or inductively heatable. The separating capillary can be heated indirectly via the envelope capillary by arranging the separating capillary in the envelope capillary.

A material mixture to be separated by the gas chromatograph, in particular the temperature gradient gas chromatograph, and to be analyzed, and a carrier gas, which is used to transport the material mixture to be separated and analyzed, is applied to the separating capillary of the device described herein for a gas chromatograph, in particular a temperature gradient gas chromatograph. For this purpose, the material mixture and the carrier gas are supplied to the separating capillary via the first end of the separating capillary. The material mixture and the carrier gas can later be discharged from the separating capillary via the second end.

The separating of the material mixture to be analyzed using the described device is enabled, for example, by a predefined local heat balance equilibrium along the separating capillary. In other words, at each point along the axial extension of the separating capillary, a rate of the supplied heat corresponds to a rate of the discharged heat. The rate of the supplied heat is in this context the quantity of the supplied heat in relation to a unit of volume and a unit of time. The rate of the discharged heat is in this context the quantity of the discharged heat in relation to a unit of volume and a unit of time.

For example, the local heat balance equilibrium, i.e., the local temperature, can be constant along the axial extension of the separating capillary. For example, the constant profile of the temperature can be implemented by a constant rate of the supplied heat from the first end of the separating capillary to the second end of the separating capillary, while the rate of the discharged heat is also constant along the separating capillary.

In another example, the local heat balance equilibrium, i.e., the local temperature along the axial extension of the separating capillary can have a mathematically monotonously extending gradient. For example, the gradient can be implemented by a rate of the supplied heat increasing or decreasing from the first end of the separating capillary to the second end of the separating capillary, while the rate of the discharged heat along the separating capillary is constant. A rate of the supplied heat increasing or decreasing from the first end of the separating capillary to the second end of the separating capillary can be produced, for example, with resistive heating of the separating capillary by an electrical resistance of the separating capillary rising or sinking from the first end of the separating capillary to the second end of the separating capillary.

Alternatively or additionally, the gradient of the temperature along the separating capillary can be implemented by a rate of the discharged heat increasing or decreasing along the separating capillary, while the rate of the supplied heat is constant along the separating capillary or also gradually varies.

As mentioned above, the separating capillary is arrangeable or arranged in the controllable fluid flow field. If the separating capillary is arranged in the controllable fluid flow field, for example, the rate of the discharged heat is influenced by the corresponding arrangement of the separating capillary in the controllable fluid flow field, where the fluid flow field is definable and cools the heatable separating capillary during an analysis of a material or material mixture to be analyzed. Accordingly, during the analysis, a fluid flows around the separating capillary, the flow speed of which is controllable and defined. Details with respect to the formation of the flow field are explained elsewhere herein.

The fluid flowing around the separating capillary can be, for example, a gas or a gas mixture. In practice, the use of air has proven itself. In particular at higher temperatures, gases having a low reaction rate can additionally or alternatively be used in order to prevent an undesired reaction of the fluid with the device. For example, nitrogen or any inert gas can be used as a gas having a low reaction rate.

The device according to the system described herein includes the generating device that generates the controllable and defined fluid flow field. The generating device can be implemented in various ways. For example, a fluid flow is generated by the generating device with a flow speed of greater than 0.01 m/s and less than 10 m/s, preferably greater than 0.1 m/s and less than 1 m/s at the separating capillary. Furthermore, it is provided, for example, that the flow speed of the fluid flow is controllable. The flow speed of a fluid flow at the separating capillary can thus be varied, for example, by the generating device. This is possible, for example, during an analysis of a material mixture to be analyzed, for example to be able to set a desired temperature gradient of the separating capillary. Any generating device can be used to generate a fluid flow which is suitable for the system described herein, for example a generating device which has the abovementioned properties. For example, at least one compressed air line or at least one compressed gas container, to which a controllable flow control valve is connected, can be used in order to generate a controllable fluid flow. A fluid guiding channel can be connected to the flow control valve, for example, which guides the fluid to the separating capillary. Alternatively or additionally, the flow control valve can be aligned directly on the separating capillary in such a way that the fluid flows directly against the separating capillary. Furthermore, at least one flow device can additionally or alternatively be used to generate a fluid flow flowing around the separating capillary. For example, the flow device is designed as a propeller, a centrifugal pump, a fan, and/or a compressor. The flow generated using the flow device can be aligned indirectly or directly on the separating capillary.

The device according to the system described herein for a gas chromatograph, in particular a temperature gradient gas chromatograph, additionally includes an influencing device for influencing the fluid flow. The influencing device is used to influence the fluid flow which is generated by the generating device. The influence provided by the influencing device is intended, for example, to convert a fluid flow having undefined fluid flow field into a fluid flow having defined fluid flow field. The conversion relates in particular to a flow speed of the fluid flow field. The influencing device is advantageous because the fluid flow field generated by the generating device is undefined and is dependent on the technical implementation of the generating device. The fluid flow field provided by the generating device is therefore not automatically suitable for generating a defined heat balance equilibrium along the separating capillary, for example a heat balance equilibrium having predefined gradient along the separating capillary. To generate a defined heat balance equilibrium, it is desirable for the flow speed of the fluid flow field to be spatially matched to the formation of the separating capillary.

Influencing of the speed of the fluid flow field and as a result the (local) temperature of the separating capillary can be carried out, for example, by a plurality of nozzles arranged in the device or by a diffuser arranged in the device. Fluid can flow against the separating capillary at a large number of positions due to the plurality of nozzles, where a defined flow speed is settable via the plurality of the nozzles following the design of the separating capillary, so that by superimposing the fluid flows of the individual nozzles, a common defined fluid flow field results. Alternatively, the speed of the fluid flow field can be influenced along the separating capillary by the diffuser aligned on the separating capillary having a design matched to the separating capillary.

Furthermore, the influencing device for influencing the speed of the fluid flow field can alternatively or additionally be designed as a sponge structure, in order to influence the speed of the flow field and thus set a defined fluid flow field. The sponge structure can be formed, for example, from plastic, metal, glass, or ceramic. A sponge structure in this context is a structure which is an open-pored skeleton. Open-pored means that the pores have connections with one another through which fluid can flow. The local permeability of the sponge structure for a fluid which is applied to the sponge structure can be influenced by a locally definable pore component and a locally definable pore structure, in particular pore size, of the sponge structure. A sponge structure is often also designated as a sponge or as an open-pored framework. The designation open-pored foam is occasionally also used for this purpose.

For example, the speed of the fluid flow field is influenced by a sponge structure, which is arranged in the device according to the system described herein and the formation, porosity, and pore structure of which are matched to the separating capillary. A fluid flow of a fluid is supplied to the sponge structure on a first side of the sponge structure or a plurality of sides of the sponge structure. The fluid flows through the sponge structure and exits from a second side of the sponge structure, influenced by the sponge structure, having defined fluid flow field of the fluid. The second side of the sponge structure faces toward the separating capillary arranged in the module. The defined fluid flow field of the fluid thus flows around the separating capillary. The fluid flow field has a gradient of the flow speed following the design of the separating capillary here, for example.

Additionally or alternatively, a cooling device can be provided for cooling the influencing device in the device according to the system described herein, in order to limit the temperature influence of the heatable separating capillary on the influencing device. For example, a cooling device for cooling the influencing device can be one channel or multiple channels, through which a cooling medium flows.

According to the system described herein, the device for a gas chromatograph, in particular for a temperature gradient gas chromatograph, includes the receptacle device for accommodating the module in which the separating capillary is arranged, where the module is insertable into the receptacle device and removable from the receptacle device. The receptacle device is used to accommodate the optional exchangeable module and results in a secure, proper positioning of the module in the device according to the system described herein, which ensures a technical functionality of the device.

The receptacle device can be designed, for example, as a framework into which the module is insertable. For example, the framework defines the position of the module in the device. Additionally or alternatively, guide rails are arranged on the framework, in which the module is insertable in only one single predefined position. The predefined position can be implemented, for example, in that the module that can be accommodated by the framework is arrangeable abutting an inside or an outside of the framework. The module can be held by a weight of the module in the predefined position by a horizontal design of the guide rails, for example.

Alternatively to a framework having guide rails, the receptacle device can be, for example, a housing provided with a recess, where the module is insertable into the recess.

The device according to the system described herein for a gas chromatograph, in particular for a temperature gradient gas chromatograph, has the advantage over the prior art of allowing a simple exchange of the modularly designed functional units, in particular the separating capillary.

Due to an achievable flat embodiment of the separating capillary, the system described herein enables a compact construction of the device according to the system described herein and also enables a simple exchange of the separating capillary. The module having the separating capillary is removable from the device, so that it is easily possible to exchange the separating capillary. As explained in more detail hereinafter, automatically or manually actuatable connections can establish a desired electrical connection and/or a desired fluidic connection.

To obtain a defined temperature of the heated separating capillary, generating a defined flow field is provided, for example. For example, generating a flow field decreasing or increasing over the length of the separating capillary can be provided, in order to obtain a uniform temperature profile along the heated separating capillary. For this purpose, for example, an inhomogeneous, centrally-symmetrical flow field lying in a plane can be provided. This is described in more detail hereinafter.

In a further embodiment of the device according to the system described herein, it is additionally or alternatively provided that the module in which the separating capillary is arranged is a first module and that a second module is provided. The influencing device for influencing the fluid flow of the fluid can be arranged in the second module. In particular, the second module can also be insertable into the receptacle device and removable from the receptacle device.

As already mentioned, it is desirable for generating a defined heat balance equilibrium having constant temperature profile along the separating capillary or having predefined gradient that the flow speed of the fluid flow field is spatially matched to the formation of the separating capillary. The influencing device can thus be arranged in the second module insofar as the fluid flow of the fluid as defined by the influencing device flows on the separating capillary when the second module is properly arranged in the receptacle device.

For a proper arrangement of the second module, the second module can be arranged on the first module. In other words, the second module can be arrangeable indirectly or directly on the first module or around the first module in any position starting from the first module. For example, the second module can be arranged on the first module so that the first module and the second module adjoin one another flush. In this context, adjoining one another flush means that the modules are directly in contact via one of each of sides of modules and the sides in contact are essentially congruent.

For example, the first module is designed as a first cassette. Furthermore, for example, the second module is likewise designed as a second cassette. The first cassette and the second cassette are, for example, arranged in any arbitrary position in relation to one another. For example, the first cassette and the second cassette are arranged adjoining one another in series. Additionally or alternatively, it is provided that the second module is insertable into the first module or that the first module is insertable into the second module. For example, the first module is designed as a first pipe and the second module as a second pipe. The first pipe has, for example, a larger internal diameter than the external diameter of the second pipe. The second pipe can then be accommodated in the first pipe. This applies accordingly when the second pipe has a larger internal diameter than the external diameter of the first pipe. The first pipe can then be accommodated in the second pipe.

As mentioned above, the second module is insertable into and removable from the receptacle device. This can take place, for example, in the same way as the insertion and the removal of the first module. In particular, the device according to the system described herein can include guide rails on the receptacle device for accommodating the second module, in which the second module is insertable in only a single predefined second position into the receptacle device. In a further embodiment of the device according to the system described herein, it is additionally or alternatively provided that the receptacle device fundamentally includes two receptacle devices, namely a first receptacle device for accommodating the first module and a second receptacle device for accommodating the second module.

In still a further embodiment of the device according to the system described herein, it is additionally or alternatively provided that the generating device is arranged in or on the first module. Furthermore, it is additionally or alternatively provided that the generating device is arranged in or on the second module. Of course, the generating device can also alternatively or additionally be arranged on a base body of the device according to the system described herein. An arrangement in the first module or in the second module means that the generating device is exchangeable. Furthermore, this means that the generating device is at least partially enclosed by the outer shape of the first module or is at least partially enclosed by the outer shape of the second module. An arrangement on the first module or on the second module means that the generating device is arranged outside the outer shape of the first module or outside the outer shape of the second module.

If the generating device is arranged in the first module or in the second module, the generating device is then part of the respective module in which the generating device is arranged. The respective module then includes at least two functionally closed functional units. The at least two functionally closed functional units can include, for example, the separating capillary and the generating device. In another embodiment, the at least two functionally closed functional units can include the influencing device for influencing the speed of the fluid flow field and the generating device for generating a fluid flow.

If the generating device is arranged on the first module, on the second module, and/or on the base body of the device according to the system described herein, the generating device is then not part of the respective module on which the generating device is arranged. The generating device can be arranged indirectly or directly on the first module, on the second module, and/or on the base body of the device according to the system described herein. That is to say, for example, a fluid line can be provided or no fluid line can be provided.

An arrangement of the generating device in the first module or in the second module can have the advantage of a particularly compact structural form of the overall device according to the system described herein. An arrangement of the generating device on the first module, on the second module, and/or on the base body of the device according to the system described herein can have the advantage of a simpler construction and a particularly compact structural form of the first module and the second module. The arrangement of the generating device in close proximity to the separating capillary, i.e., for example, in the first module, in the second module, on the first module, on the second module, or on the base body of the device according to the system described herein at a few millimeters or centimeters distance from the separating capillary and/or the influencing device offers the advantage of a particularly short flow path of the fluid flow from the generating device to the separating capillary and/or the influencing device. The temperature of the separating capillary is thus influenceable by a particularly well definable and controllable flow field.

An arrangement of the generating device in or on the first module can be implemented, for example, in that the generating device is connected in a friction-locked, form-fitting, or materially-bonded manner to a housing of the first module.

An arrangement of the generating device in or on the second module can be implemented, for example, in that the generating device is connected in a friction-locked, form-fitting, or materially-bonded manner to a housing of the second module. An arrangement of the generating device on the base body of the device according to the system described herein can also be implemented, for example, in that the generating device is connected in a friction-locked, form-fitting, or materially-bonded manner to a housing of the device according to the system described herein. For example, the housing at least partially has a recess for a through flow of a fluid flow at the connecting point to the generating device. In particular, a fan can be screwed onto a housing of the device according to the system described herein and/or the second module so that a fluid can be aspirated from outside the device according to the system described herein and/or the second module and that the fluid is discharged in an area of the device in which the influencing device is arranged, for example in the second module.

In still a further embodiment of the device according to the system described herein, it is additionally or alternatively provided that the generating device is a first generating device for generating a fluid flow. In addition, the device according to the system described herein includes a second generating device for generating a second fluid flow. The second generating device for generating a fluid flow is used, for example, for a controlled discharge of fluid flowing around the separating capillary away from the separating capillary. The second generating device can additionally, at least in an assisting manner, generate the fluid flow which flows around the separating capillary. It is not required for the second generating device to be controllable for the controlled removal of the fluid flowing around the separating capillary. However, the second generating device can be controllable.

In particular if the device according to the system described herein represents an essentially closed formation or a closed formation, it is desirable if at least the same fluid volume flow rate can be put through using the second generating device as using the first generating device. In this case, the inflow of the fluid, generated by the first generating device, in the device with respect to a unit of time corresponds to the outflow of the fluid, generated by the second generating device, with respect to a unit of time. A controlled flow field of the fluid flow is thus implementable and a pressure increase in the device according to the system described herein is avoidable.

In still a further embodiment of the device according to the system described herein, it is additionally or alternatively provided that the device includes a third module. The second generating device can then be arranged in the third module.

For example, the third module is designed as a third cassette. If, for example, the first module, the second module, and the third module are designed as a first, a second, and a third cassette, the first cassette, the second cassette, and the third cassette are arrangeable in any arbitrary position in relation to one another. For example, the cassettes can be arranged adjoining one another in series, where the first cassette is arranged in the middle between the second cassette and the third cassette.

Additionally or alternatively, it is provided that the third module is insertable into the first module or that the first module is insertable into the third module. For example, the first module is designed as a first pipe, the second module as a second pipe, and the third module as a third pipe. The first pipe has, for example, a larger internal diameter than the external diameter of the second pipe. The third pipe has, for example, a larger internal diameter than the external diameter of the first pipe. The second pipe can then be accommodated in the first pipe and the first pipe can be accommodated in the third pipe.

In still a further embodiment of the device according to the system described herein, it is additionally or alternatively provided that the device according to the system described herein includes a receptacle device for accommodating the third module, where the third module is insertable into the receptacle device and removable from the receptacle device. For example, the abovementioned receptacle device is a third receptacle device, which is part of the receptacle device that includes the abovementioned first receptacle device and second receptacle device. Alternatively thereto, it can be provided that the first receptacle device, the second receptacle device, and/or the third receptacle device are receptacle devices separate from one another. The third module-like the first module and/or the second module-is exchangeable due to the third receptacle device. For example, the first receptacle device, the second receptacle device, and the third receptacle device are arranged such that the first module, the second module, and the third module are each arrangeable adjoining one another flush in a predefined position in the device.

In one embodiment of the device according to the system described herein, it is additionally or alternatively provided that at least one of the modules from the set of the first module, the second module, and the third module includes at least one connecting device for the connection to at least one further module of the abovementioned set. A connecting device in this context means a mechanical connecting device having at least one passage opening through which fluid can flow, which permits a flow of a fluid from one of the modules from the set of the first module, the second module, and the third module into at least one further module of the abovementioned set.

Embodiments of the mechanical connecting device for the abovementioned modules, thus the first module, the second module, and the third module, are explained in more detail hereinafter.

If one of the abovementioned modules does not have a closed structural form, but rather is designed as openly accessible in that the outer form of the module is defined, for example, by a framework, an at least partially open housing, or by the closed functional unit itself contained in the module, a separate mechanical connecting device is not required, because a connection through which fluid can flow between the modules can be ensured in that the abovementioned modules are arranged directly adjoining one another in the receptacle device of the device according to the system described herein.

If the abovementioned modules have structural forms having substantially closed housings, then the connecting device includes, for example, recesses in the respective housings of the abovementioned modules which directly abut one another so that fluid can flow through the recesses when the abovementioned modules are arranged in a predefined position in the respective receptacle devices. Alternatively or additionally, the connecting devices can include intermediate units, for example, which are arranged between the modules to be connected and indirectly connect recesses in the housings of the modules to be connected. A mechanical connecting device can in this case be a perforated plate, for example, on which one or a plurality of the abovementioned modules can rest so that the recess in the housing rests precisely on a hole of the perforated plate. A further module from the set of the first module, the second module, and the third module can be arranged below the perforated plate. The further module can also include a recess in the housing, which is congruent with the abovementioned hole of the perforated plate, so that the housings of the modules are connected via the perforated plate so that fluid can flow through the hole and the recess.

If the abovementioned modules have structural forms having completely closed housings, the connecting device then includes, for example, sections in the housings of the abovementioned modules which can be opened with the aid of an actuator. In particular, the sections indirectly or directly abut one another when the abovementioned modules are arranged in a predefined position in the respective receptacle devices. For example, at least one of the abovementioned modules having closed housing can include a flap or a plurality of flaps in the housing which can be opened electrically, hydraulically, or pneumatically. If the modules are arranged directly or indirectly (for example separated by a perforated plate) on one another and a connection or connections is/are to be established between two or more of the modules, the flaps can be opened to configure a connection between the modules through which fluid can flow.

In the embodiments of the system described herein and explained in more detail hereinafter, which include a first module, a second module, and a third module, distributing the functions of the device according to the system described herein onto the abovementioned modules is provided, for example. The separating capillary is thus arranged in the first module, for example. The first generating device for generating a fluid flow, which generates a centrally-symmetrical fluid flow, for example, is arranged in the second module, for example. In contrast, the second generating device for generating a fluid flow is arranged in the third module, for example. The second generating device is used, for example, for a controlled removal of fluid flowing around the separating capillary away from the separating capillary. In addition, the third module having the second generating device is used to stabilize the flow field. Furthermore, it is provided, for example, that after the end of a measurement, the separating capillary has direct incident flow by way of the second generating device arranged in the third module, so that the separating capillary is cooled.

In a further embodiment of the device according to the system described herein, it is additionally or alternatively provided that the module (thus the first module) includes at least one first attachment device for attaching the separating capillary to a sample dispensing device for dispensing the material to be analyzed and a carrier gas into the separating capillary. As mentioned above, the separating capillary is supplied with the material mixture to be analyzed or the material to be analyzed, on the one hand, and the carrier gas, on the other hand, via the first end of the separating capillary. The first attachment device for attaching the separating capillary to a sample dispensing device is therefore arranged, for example, at the first end of the separating capillary.

The first attachment device is designed so that when the separating capillary is attached to a sample dispensing device, an opening through which fluid can flow is present between the separating capillary and the sample dispensing device and that the connection is closed gas-tight to the outside. For this purpose, the first attachment device can include an extension of the tube of the separating capillary, a connecting device, and a transfer line. The extension of the tube is preferably formed from a solid and ductile material, for example a metal, and is connected gas-tight to the separating capillary, for example by adhesive bonding, soldering, or welding. It can also include an end section of the capillary itself. The extension of the separating capillary can fluidically connect the separating capillary to the connecting device. The connecting device can include two sections which are connectable gas-tight to one another. A first section is arranged on the transfer line, which is fluidically connected to the sample dispensing device. A second section is connected to the extension of the tube. Therefore, during or after an insertion of the module (or the first module) into the receptacle device, the separating capillary can be attached via the abovementioned attachment device to the sample dispensing device. The connecting device of the attachment device can be disconnected again for a removal of the module (or the first module).

The sample dispensing device can in particular be a vaporizing injector, for example a commercially available split/splitless injector. The vaporizing injector, in which, for example, the material mixture to be analyzed is vaporized and is mixed at the same time with the carrier gas, can be accommodated by the first receptacle device of the separating capillary, for example, via an opening on one side of the vaporizing injector.

Alternatively or additionally to the first attachment device for attaching the separating capillary to a sample dispensing device, the module (thus the first module) can include a second attachment device for attaching the separating capillary to a detection device for detecting the material to be analyzed or the material mixture to be analyzed. Additionally or alternatively, the second attachment device is used for attachment to a further unit of the device according to the system described herein. As mentioned above, for example, the material mixture to be analyzed and the carrier gas are discharged from the separating capillary via the second end. The second attachment device is therefore arranged, for example, at the second end of the separating capillary. The second attachment device is designed so that when the separating capillary is attached to a detection device, an opening through which fluid can flow is present between the separating capillary and the detection device and that the connection is closed gas-tight to the outside. The second attachment device is additionally designed so that the separating capillary is alternatively attachable to a further unit of the device for a gas chromatograph, in particular a temperature gradient gas chromatograph. A connection between the second attachment device and the further unit of the device for a gas chromatograph, in particular a temperature gradient gas chromatograph is also, for example, an opening through which fluid can flow and which is closed gas-tight to the outside.

The explanations above apply for the design of the second attachment device as for the design of the first attachment device.

A detection device can in particular be a mass spectrometer attached via the second attachment device to the second end of the separating capillary. However, other detection devices, for example, a flame ionization detector, a photoionization detector, and/or other detectors can also be used. The invention is not restricted to the abovementioned embodiments. Rather, any detection device which is suitable for the invention can be used for the invention.

A further unit of the device for a gas chromatograph, in particular a temperature gradient gas chromatograph, can in particular be at least one second separating capillary, which is attached to the second end of the first separating capillary. In the context of gas chromatography, a gas chromatograph in which a second separating capillary is attached to the first separating capillary is designated as a two-dimensional gas chromatograph. The second separating capillary is used here for a further separation of a subset of the material mixture analyzed using the first separating capillary. More than two separating capillaries can also be attached to one another in series in the flow direction of the material mixture to be analyzed. In this case, the gas chromatograph is a multidimensional gas chromatograph. The second end of the last separating capillary of the plurality of separating capillaries connected in series in the flow direction of the material mixture to be analyzed is normally provided with an attachment device for attaching the last separating capillary to a detection device.

If the device according to the system described herein includes two or more separating capillaries, the separating capillaries can then all be arranged in the module (thus in the first module). Alternatively, the separating capillaries can be arranged individually in separate modules, so that the device includes a plurality of modules which technically correspond to the first module, where each of the modules includes a different separating capillary and the plurality of the modules are connected in series via respective separating capillaries of the modules so that fluid can flow through the separating capillaries in a flow direction of the material mixture to be analyzed.

In still a further embodiment of the device according to the system described herein, it is additionally or alternatively provided that the first attachment device includes at least one first insulator and/or at least one first heating device for setting a temperature of the first attachment device. It is advantageous if the first attachment device is heatable to a temperature above the temperature of the separating capillary, so that during the analysis of a material mixture to be analyzed, no components of the material mixture to be analyzed adsorb in the first attachment device.

The first insulator can be formed, for example, from a thermally insulating material which is arranged at least partially around the first attachment device, optionally also around the sample dispensing device. The first heating device can be, for example, an electrical heater or a furnace chamber in which the first attachment device and optionally the sample dispensing device is or are arranged.

Alternatively or additionally, the first attachment device includes at least one quick connecting device for quickly connecting the separating capillary to the sample dispensing device. A quick connecting device for quickly connecting the separating capillary to the sample dispensing device is designed so that the separating capillary and the sample dispensing device can be connected gas-tight in a simple and rapid manner, as soon as the first module is inserted in the predefined position in the receptacle device. In a preferred embodiment, the quick connecting device is not closable when the first module is not inserted in the predefined position in the receptacle device. A precisely fitted and secure alignment of the separating capillary on the sample dispensing device and on the influencing device for influencing the fluid flow is thus achieved.

For example, the quick connecting device can be a plug connection in such a way that the transfer line arranged on the sample dispensing device includes a pickup. A plug, which is arranged on the first end of the separating capillary, can be inserted into the pickup, for example, so that a connection through which fluid can flow is present. Alternatively or additionally, the quick connecting device can include a hose clamp, which at least partially encloses the transfer line arranged on the sample dispensing device and the first end of the separating capillary. Furthermore, the quick connecting device can alternatively include a sleeve, which can be screwed from the transfer line at least partially onto the first end of the separating capillary, or which can be screwed from the first end of the separating capillary at least partially onto the sample dispensing device.

It is likewise alternatively or additionally provided in the device according to the system described herein that the second attachment device includes at least one second insulator and/or at least one second heating device for setting a temperature of the second attachment device, so that a temperature above a temperature of the heatable separating capillary is settable on the second attachment device. As in the first attachment device, the second insulator can be formed, for example, from a thermally insulating material, which is arranged around the second attachment device and at least partially around the detection device. The second heating device can be, for example, an electrical heater or a furnace chamber, in which the second attachment device, the first attachment device, and the sample dispensing device can be arranged. Otherwise, the same explanations as for the design of the first insulator and/or the first heating device on the first attachment device apply to the design of the second insulator and/or the second heating device on the second attachment device.

Likewise alternatively or additionally, the second attachment device includes at least one second quick connecting device for quickly connecting the separating capillary to the detection device. The abovementioned description of the first quick connecting device on the first attachment device also applies to the second quick connecting device on the second attachment device.

In still a further embodiment of the device according to the system described herein, it is additionally or alternatively provided that the module (thus the first module), in which the separating capillary is arranged, is insertable into the receptacle device such that upon insertion of the module, a connection of the module to the influencing device is automatically established. Alternatively thereto, it is provided in still a further embodiment of the device according to the system described herein that upon insertion of the module, a connection of the module to the influencing device and to the second generating device for generating a fluid flow is automatically established.

The automatic establishment of the connection can be implemented in particular in that the receptacle device has a predefined position for the module insertable therein, for example the first module. If multiple modules are arranged exchangeably in the device according to the system described herein (for example the first module, the second module, and/or the third module), the receptacle device or the plurality of receptacle devices then has/have predefined positions for the modules insertable therein. This can be provided in particular if the influencing device is arranged in the exchangeable second module and/or if the second generating device for generating a fluid flow is arranged in the third module. The predefined positions are distinguished in that the module inserted in the receptacle device or the modules inserted into the plurality of receptacle devices are arranged in a predefined position relative to one another and to the receptacle device. In an exemplary predefined position of the modules, the first module, the second module, and the third module are arranged adjoining one another flush in a series, for example stacked one on top of another, where the first module is arranged between the second module and the third module.

If the device according to the system described herein is a device for a multidimensional gas chromatograph, in particular a multidimensional temperature gradient gas chromatograph, all modules which technically correspond to the first module can then be arranged between the influencing device and the optional second generating device for generating a fluid flow. If the influencing device is arranged in the second module and the second generating device is arranged in the third module, all modules which technically correspond to the first module can be arranged between the second and an optional third module. With a predefined position of the modules of the above-described type, for example, a connecting device of the above-described device for connecting the respective modules is arranged between the first module and the second module and between the first module and the third module.

A position of the respective abovementioned modules can be predefined, for example, in that the receptacle device or the plurality of receptacle devices is designed as a framework, in which the first module and/or the second module and/or the third module are each insertable in a defined position and which includes, for example, guide rails, on which the respective modules can be inserted into the receptacle device. Alternatively or additionally, the modules can each be arranged in predefined positions in that pressure elements and/or clamping elements which are arranged on the respective modules pass from a readiness position into a locking position when the respective modules assume a predefined position. For example, the pressure elements and/or clamping elements can be pins which are arranged on one of the modules from the set of the first module, the second module, and the third module and, loaded by a spring force, snap into a recess on an adjoining module of the abovementioned set.

In a further embodiment of the device according to the system described herein, it is additionally or alternatively provided that the first module, in which the separating capillary is arranged, is insertable into the receptacle device such that upon the insertion of the first module, a connection of the first module to the sample dispensing device and/or to the detection device can be manually established or is automatically established.

The manual establishment of the connection can be carried out, for example, manually by an operator of the device according to the system described herein in that the operator closes the first attachment device and/or the second attachment device. The automatic establishment of the connection can be implemented in particular in that the receptacle device has a predefined position for the first module insertable therein, as described above. In this case, the likewise above-described quick connections on the first attachment device and on the second attachment device can be automatic quick connections on a detection device.

Automatic quick connections can be, for example, plug connections. In particular, the plug connections can be designed in such a way that the separating capillary and the sample dispensing device or the separating capillary and the detection device, respectively, can be connected gas-tight in an automatic manner as soon as the first module is inserted in the predefined position in the receptacle device. A leak-tight connection can be achieved in this case, for example, in that a first plug arranged at the first end of the separating capillary is inserted into a first socket. Furthermore, a second plug arranged at the second end of the separating capillary can be inserted into a second socket. An elastic sealing mechanism is arranged, for example, between the first end of the separating capillary and the first socket and between the second end of the separating capillary and the second socket. A quick, precisely fitted, and secure alignment of the separating capillary on the sample dispensing device can be achieved by a plug connection, for example.

In one embodiment of the device according to the system described herein, it is additionally or alternatively provided that the separating capillary has an essentially spiral-shaped or spiral-shaped wound design. The spiral-shaped or essentially spiral-shaped design is in particular a planar spiral, for example an Archimedean spiral, a parabolic spiral, or a logarithmic spiral. However, the spiral can also be a three-dimensional spiral. The entire separating capillary does not have to be designed as a spiral here. In particular, two end sections of the separating capillary, at which the first attachment device for attaching the separating capillary to a sample dispensing device and the second attachment device for attaching the separating capillary to a detection device are arranged, can deviate from the design of a spiral. For example, a first end section of the spiral is designed so that the first end section leads radially, i.e., linearly, outward beyond the spiral from an inner radius of the spiral. For example, the first end section leads to the housing of the first module. For example, the first attachment device, which can be attached to the sample dispensing device or to the detection device, can be arranged at the first end section. A second end section of the separating capillary is designed so that, for example, the second end section leads tangentially away from the spiral from the outer radius of the spiral. The second end section of the separating capillary can also lead to the housing of the first module, for example. The second attachment device, which can connect the separating capillary to the sample dispensing device or to the detection device, can be arranged at the second end section of the separating capillary. In addition, for example, the first end section and the second end section are insulated. In particular, the end sections are enclosed by a thermally insulating material.

The abovementioned embodiment has the advantage that a compact design is enabled. The helical design of the separating capillary, which is used in the prior art, is replaced in the system described herein, for example, by a spiral-shaped design of the separating capillary, which is arranged essentially in one plane. This means that the separating capillary designed in this way is arranged in one plane and only extends with a minor height from the one plane. The spiral-shaped separating capillary is therefore made quite flat, for example having a height less than 20 cm or less than 10 cm or less than 5 cm. A large volume as in the helical separating capillary known from the prior art is avoided. The spiral-shaped separating capillary enables the design of the separating capillary having a length which is sufficient to carry out a gas chromatography measurement.

If the separating capillary is designed as an Archimedean spiral, the length L of the separating capillary may then be calculated as follows:

$$L ( t ) = \frac{1}{2} k ( arsinh ( t ) + t \sqrt{{t}^{2} + 1} )$$

where
L is the length of the separating capillary;
t is an angle in polar coordinates (therefore IT corresponds to) 180°; and
k is a selectable factor, where the following applies: r=k·t, where r is the radius in polar coordinates at the angle t and the polar coordinates are given by x(t)=k·t·cos t and y (t)=k·t·sin t. At k=1/(2π) the spacing of the spiral tracks of the spiral-shaped separating capillary is equal to 1.

For example, the length of the separating capillary designed as an Archimedean spiral having an initial radius of 2 cm (radius of a first spiral of the spiral-shaped separating capillary) and an end radius of 10 cm (radius of the last spiral of the spiral-shaped separating capillary) is approximately 300 cm if the spacing of the spiral tracks is 1 cm. The diameter of the entire spiral-shaped separating capillary is approximately 20 cm. With a reduced spacing of 0.5 cm, the length is doubled to approximately 600 cm.

In a further embodiment of the device according to the system described herein, it is additionally or alternatively provided that the influencing device is designed in such a way that the fluid, after flowing through the influencing device, has an essentially centrally-symmetrical or centrally-symmetrical flow field. A centrally-symmetrical field is often also designated as a point-symmetrical field. The formation of the centrally-symmetrical flow field is related here to a two-dimensional distribution (thus along a first spatial direction and along a second spatial direction) of the speed of the fluid flow orthogonally to the flow direction. The flow field can also vary along a third spatial direction, i.e., along the flow direction of the fluid flow. However, this is not absolutely required.

A centrally-symmetrical field is characterized in that the field is mapped on itself when it is rotated by 180° around a central point of the field. In other words, a flow field has a centrally-symmetrical speed distribution when the speed in an arbitrary point of the flow field corresponds to the speed in the point resulting by the mirroring of the arbitrary point at the central center point of the field.

One example of an embodiment having a centrally-symmetrical flow field is when the separating capillary is designed as planar and spiral-shaped and is arranged horizontally in the first module, and the influencing device is arranged flatly below or above the spiral. The influencing device can then influence a fluid flow field flowing orthogonally to the plane of the separating capillary, where a cross section of the fluid flow field is parallel to the plane of the spiral and can have any arbitrary centrally-symmetrical shape. The shape of the cross section is decisively defined by the design of the influencing device. For example, a large number of nozzles in a specific arrangement, for example arranged in a circle, can be aligned on the separating capillary, due to which a flow field having circular cross section results. Alternatively, a sponge structure in the form of a circle can be arranged above or below the separating capillary and can have air flowing through the sponge structure, due to which a flow field having circular cross section also results.

As explained in more detail hereinafter, the centrally-symmetrical flow field is generated in the second module. In one embodiment, it is additionally or alternatively provided that the fluid is cooled in the second module. For this purpose, for example, a cooling device, in particular in the form of a cooling circuit, is arranged on the second module or in the second module.

In a further embodiment of the device according to the system described herein, it is additionally or alternatively provided that the fluid flow field is designed as a homogeneous fluid flow field or as an inhomogeneous fluid flow field. In still a further embodiment of the device according to the system described herein, it is additionally or alternatively provided that the fluid, after flowing through the influencing device, includes the homogeneous or the inhomogeneous flow field (also called a fluid flow field hereinafter).

The homogeneous fluid flow field results, for example, in a constant rate of the discharged heat along the separating capillary. In other words, a constant rate of the discharged heat along the separating capillary takes place, for example, due to a constant flow speed along the axial extension of the separating capillary of the fluid flowing around the separating capillary.

The homogeneous flow field can be generated, for example, in that the abovementioned nozzles are arranged equidistantly and the fluid flows out of the nozzles at equal or essentially equal flow speed. A homogeneous flow field then results due to the superposition of the flows from the nozzles. Alternatively, a homogeneous flow field can be generated, for example, in that the abovementioned sponge structure has a homogeneous pore structure and the fluid flows through the sponge structure uniformly. In particular, the fluid can flow against the sponge structure from the abovementioned first side, so that the fluid flows through the sponge structure and leaves the sponge structure on the second side, which is opposite to the first side. From this second side, the fluid can then flow as a homogeneous flow to the separating capillary.

Additionally or alternatively, the inhomogeneous flow field results, for example, in an increasing or decreasing rate of the dissipated heat along the separating capillary. The inhomogeneous flow field has, for example, a gradually increasing flow speed or gradually decreasing flow speed along the axial extension of the separating capillary. A higher heat discharge rate is implemented by a higher flow speed of the fluid flowing around the separating capillary than by a lower flow speed of the fluid flowing around the separating capillary. Therefore, with a constant heat supply rate along the separating capillary, a temperature rising from the first end of the separating capillary to the second end of the separating capillary is implemented by a flow speed decreasing from the first end of the separating capillary to the second end of the separating capillary. Accordingly, a temperature sinking from the first end of the separating capillary to the second end of the separating capillary is achieved with a flow speed of the fluid rising toward the second end of the separating capillary.

The inhomogeneous fluid flow field can be formed in that the abovementioned nozzles are arranged equidistantly and the fluid flows out of the nozzles at unequal flow speed. An inhomogeneous flow field then results due to the superposition of the flows from the nozzles. Alternatively, the inhomogeneous flow field can be generated, for example, in that the abovementioned sponge structure has a homogeneous pore structure and the fluid flows through the sponge structure unevenly. In particular, the uneven flow through the sponge structure can be achieved if the fluid flows against the sponge structure from a third side, which is arranged transversely to the second side, for example, so that the fluid flows through the sponge structure and leaves the sponge structure on the second side. From the second side, the fluid can then flow as an inhomogeneous flow to the separating capillary. The inhomogeneous flow is formed in this case, for example, in that the length of the path which the fluid covers in the sponge structure is dependent on the point at which the fluid leaves the sponge structure.

Due to the quite flat and heated separating capillary and the planar, inhomogeneous, and centrally-symmetrical flow field, an arrangement of the first module and the second module aligned orthogonally to the surfaces of the spiral-shaped separating capillary and the flow field generates the desired constant temperature over the length of the capillary. Alternatively, the arrangement generates the desired temperature profile over the length of the separating capillary. The device according to the system described herein is therefore capable of generating a homogeneous temperature or a temperature profile along the separating capillary. For this purpose, the influencing device for influencing the fluid flow is flexibly adaptable.

In still a further embodiment of the device according to the system described herein, it is additionally or alternatively provided that the flow speed of the centrally-symmetrical inhomogeneous flow field increases with increasing distance from a center of the flow field. In particular, the flow speed can vary in the cross-sectional plane of the fluid flow field. As described above, the fluid flow field can have an inhomogeneous speed distribution. If the inhomogeneously distributed speed increases radially outward from a central center point of the fluid flow field, the flow field is then centrally-symmetrical and inhomogeneous.

The embodiment where the flow speed of the centrally-symmetrical inhomogeneous flow field increases with increasing distance from a center of the flow field can be achieved, for example, if a sponge structure, which is centrally-symmetrical and is arranged spaced apart in parallel below or above a planar, spiral-shaped separating capillary has a permeability to the fluid increasing from the central center point of the sponge structure outward. In particular, a sponge structure generating the above-described fluid flow field can be arranged congruently above or below a separating capillary designed as a planar spiral. In this case, the heat discharge rate generated by the fluid flow field on the separating capillary increases with the radius of the planar spiral of the separating capillary. As a result, the separating capillary designed as a spiral can have a temperature decreasing with the radius of the spiral.

In still a further embodiment of the device according to the system described herein, it is additionally or alternatively provided that the flow speed of the centrally-symmetrical flow field decreases with increasing distance from a center of the flow field. As described above, the flow speed can vary in the cross-sectional plane of the fluid flow field. If the speed decreases radially outward from a central center point of the fluid flow field, the flow field is then also centrally-symmetrical and inhomogeneous.

The embodiment where the flow speed of the centrally-symmetrical flow field decreases with increasing distance from a center of the flow field can be achieved, for example, if the fluid permeability of a sponge, which is centrally-symmetrical and is arranged spaced apart in parallel below or above a planar, spiral-shaped separating capillary, decreases outward from the central center point of the sponge. Moreover, the same explanations apply to the centrally-symmetrical flow field having a speed distribution decreasing from a center of the flow field as to the centrally-symmetrical flow field having a speed distribution increasing from a center of the flow field.

In one embodiment of the device according to the system described herein, it is additionally or alternatively provided that at least one flow director device for setting a homogeneous flow direction of the fluid flow is arranged along the separating capillary. A flow director device is a device which aligns the flow direction of the fluid flow, which flows from the influencing device to the separating capillary, in an orientation direction. This has the advantage in particular that the fluid flow is less turbulent and a better distributed cooling of the separating capillary can thus take place. Better distributed cooling of the separating capillary is related to the separating capillary being able to have a mathematically monotonous temperature profile along an axial extension of the separating capillary, so that the material mixture to be analyzed using a gas chromatograph can be correctly separated. A mathematically monotonous temperature profile can be achieved with defined incident flow of the fluid against the separating capillary. The flow director device is arranged along the separating capillary with the goal of enabling a defined incident flow against the separating capillary without turbulence.

One exemplary embodiment of the flow director device is a band arranged along the separating capillary. In this context, a band is a planar, solid formation which extends in a first and in a second direction. In the first direction of the band, the band has an extension multiple times larger than in the second direction of the band. For example, a plastic strip can be a band. While the band follows the shape of the separating capillary along the first direction of the band in the plane of the separating capillary, the second shorter direction of the band can be oriented along the nominal flow direction of the fluid flow, which is directed by the influencing device to influence the fluid flow to the separating capillary. The flow director device can be connected, for example, via a continuous web or a plurality of webs to the first module, in particular to a framework or a housing of the first module.

The flow director device can be formed, for example, from at least one material having a low heat capacity. For example, the heat capacity of the material of the flow director device can be related to the volume and can then be less than or equal to 3.8 J/cm³K, preferably less than or equal to 2.0 J/cm³K. If the flow director device is a band, the band can be formed, for example, from a temperature-resistant plastic, for example polyimide. Alternatively or additionally, the flow director device can be formed from any other material which is suitable for the invention.

In still a further embodiment of the device according to the system described herein, it is additionally or alternatively provided that at least one temperature sensor for contactless measurement of the temperature of the separating capillary is arranged on the device for a gas chromatograph, in particular a temperature gradient gas chromatograph. The temperature sensor measures the temperature at at least one point of the separating capillary. The temperature measured by the temperature sensor at one point of the separating capillary or at a plurality of points of the separating capillary is used as an input parameter for the controllable heating power of the heatable separating capillary and the controllable fluid flow. The measured temperature is converted into an electrical signal, which is passed on to a computing unit and is compared therein to a nominal temperature of the point of the separating capillary at which the temperature was measured. Based on the comparison of the measured temperature and the nominal temperature, the computing unit computes a required heating power and a fluid flow speed, i.e., a predefined performance of the generating device, to change the measured temperature of the separating capillary such that the measured temperature comes closer to the nominal temperature. By repeatedly executed iterative comparison of the measured temperature and the nominal temperature with subsequent adjustment of the heating power and the performance of the generating device, the nominal temperature of the separating capillary can be set with great correspondence.

The contactless temperature measurement can be implemented, for example, by an optical measuring device, in particular by a pyrometer or a plurality of pyrometers. Additionally or alternatively, it can be provided that a temperature measurement is carried out using a thermocouple, which is arranged in the vicinity of the separating capillary inserted into the receptacle device. Of course, a plurality of thermocouples can also be used.

The system described herein also relates to a gas chromatograph, in particular a temperature gradient gas chromatograph, which includes a device having at least one of the preceding or following features or having a combination of at least two of the preceding or following features. The gas chromatograph according to the system described herein includes, for example, a sample dispensing device and a detection device. The sample dispensing device can be, as described above, for example, a split/splitless injector. The detection device can be, as described above, for example, a mass spectrometer. In addition, the gas chromatograph according to the system described herein includes, for example, at least one housing, in which the device of the above-described type is arranged and which terminates the gas chromatograph to the outside, so that as far as possible no fluid from the device according to the system described herein flows out of the gas chromatograph according to the system described herein and so that as far as possible no heat escapes to the outside from the gas chromatograph. The sample dispensing device and the detection device can also be arranged in the at least one housing of the gas chromatograph according to the system described herein. However, these can also be arranged outside the housing of the gas chromatograph according to the system described herein, in order to protect any sensitive sensors of the sample dispensing device and the detection device from an influence of the fluid and/or the heat in the housing of the gas chromatograph according to the system described herein. Furthermore, the gas chromatograph according to the system described herein includes, for example, a computing unit, which is connected at least to sensors of the sample dispensing device, to sensors of the detection device, to an electrically controllable element of the generating device for generating a fluid flow of a fluid, to the temperature sensor, and to an output unit. An output unit can be, for example, a plotter, which creates a chromatograph. Alternatively, the output unit can be a display.

In one embodiment of the gas chromatograph according to the system described herein, it is additionally or alternatively provided that the gas chromatograph is designed as a process temperature gradient gas chromatograph. A process gas chromatograph is distinguished by a rapid analysis of a material mixture to be analyzed, due to which online monitoring of processes, for example in the chemical industry, is possible. In particular, hydrocarbons can be analyzed in the petrochemical industry. Process temperature gradient gas chromatographs are process gas chromatographs which are based on a temperature gradient gas chromatograph.

### BRIEF DESCRIPTION OF THE DRAWINGS

Further practical embodiments and advantages of the system described herein are described hereinafter in conjunction with the drawings. In the figures:

FIG. 1 shows a first embodiment of a device as a block diagram according to the system described herein;

FIG. 2 shows a second embodiment of a device in a side view, in which a first module, a second module, and a third module are arranged one over another in a receptacle device according to the system described herein;

FIG. 3 shows an embodiment of the first module having a separating capillary arranged in the first module in a top view;

FIG. 4 shows the embodiment of the first module according to FIG. 3 in a cross-sectional view;

FIG. 5 shows a detail of the separating capillary according to FIG. 3 in a view diagonally from above;

FIG. 6a,b shows an embodiment of a first and/or second attachment device of a separating capillary having a quick connecting device;

FIG. 7 shows a further embodiment of the separating capillary diagonally from above;

FIG. 8 shows an embodiment of the second module in a cross-sectional view;

FIG. 9 shows an embodiment of the second module in a top view;

FIG. 10 shows a further embodiment of the second module in a cross-sectional view;

FIG. 11 shows still a further embodiment of the second module in a cross-sectional view;

FIG. 12 shows still a further embodiment of the second module in a cross-sectional view;

FIG. 13 shows the embodiment of the second module of FIG. 12 in a cross-sectional view;

FIG. 14 shows an embodiment of a third module in a cross-sectional view;

FIG. 15 shows the first module, the second module, and the third module, each in a possible embodiment, arranged one over another in a cross-sectional view; and

FIG. 16 shows an embodiment of a gas chromatograph in a cross-sectional view according to the system described herein having a device according to the system described herein.

### DETAILED DESCRIPTION OF VARIOUS EMBODIMENTS

The device according to the system described herein for a gas chromatograph, in particular a temperature gradient gas chromatograph, according to one possible embodiment is described hereinafter with reference to the figures. The figures are used to facilitate comprehension. Elements in the figures are schematically shown and are not to scale.

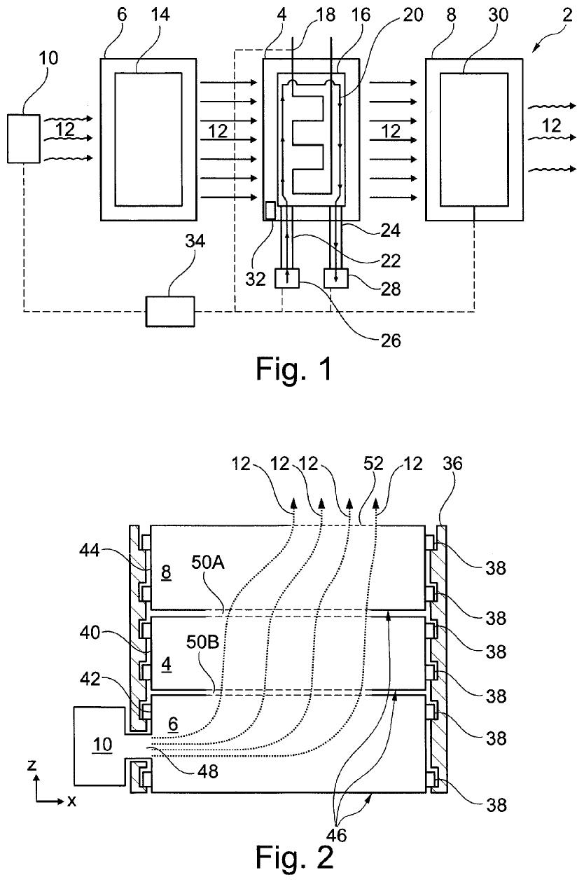

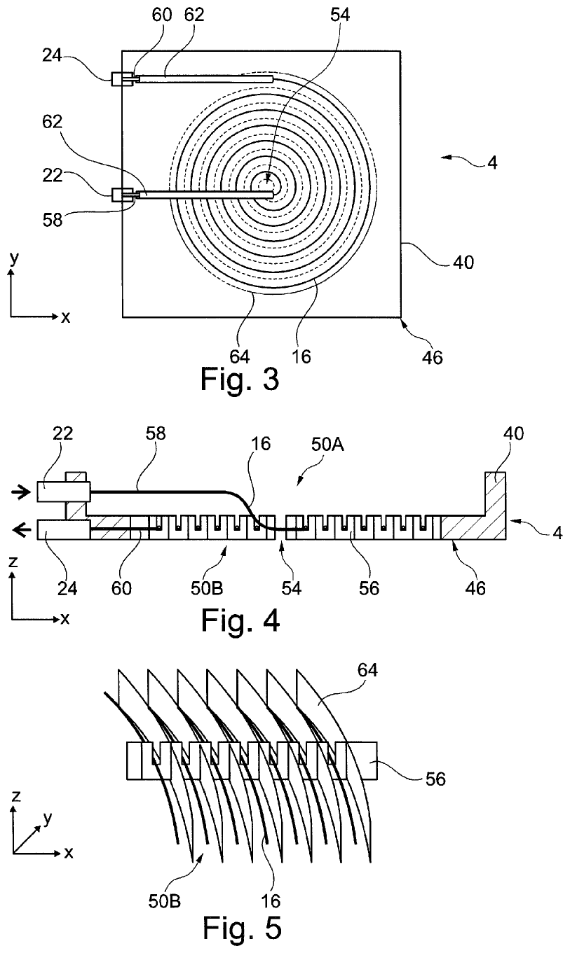

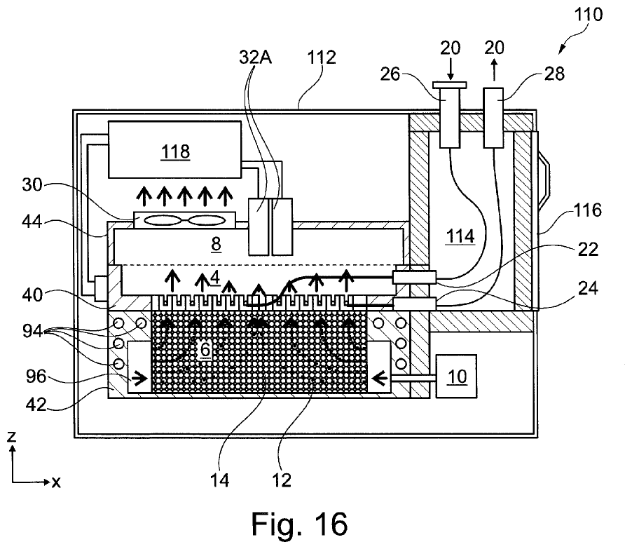

With FIGS. 1 and 2, initially an overview of an embodiment of the device according to the system described herein for a gas chromatograph, in particular a temperature gradient gas chromatograph, is described on the basis of a device for a temperature gradient gas chromatograph. Furthermore, the interaction of diverse components of the device according to the system described herein is described. For this purpose, the described embodiment of the device according to the system described herein includes three modules. Possible embodiments of a first module, a second module, and/or a third module of the device according to the system described herein are described on the basis of FIGS. 3 to 15. An embodiment of a temperature gradient gas chromatograph is described on the basis of FIG. 16.

FIG. 1 shows the device 2 according to the system described herein for a gas chromatograph, in particular a temperature gradient gas chromatograph, as a block diagram. The device 2 according to the system described herein includes a first module 4, a second module 6, and a third module 8. Furthermore, the device 2 according to the system described herein includes a first generating device 10 for generating a fluid flow of a fluid 12. The first module 4, the second module 6, the third module 8, and the first generating device 10 are arranged in the embodiment of the device 2 according to the system described herein shown in FIG. 1 so that the fluid flow of the fluid 12 generated by the first generating device 10 can flow essentially linearly through the first module 4, the second module 6, and the third module 8. Linearly means that the fluid flow of the fluid 12 is not deflected. In particular, the fluid flow of the fluid 12 is not deflected between the first module 4 and the third module 8. The arrangement of the first module 4, the second module 6, the third module 8, and the first generating device 10 are not limited to the form shown in FIG. 1. Rather, in practice any other arrangement of the first module 4, the second module 6, the third module 8, and the first generating device 10, which is suitable for the invention, can also be used.

Of course, it is also possible that the device 2 according to the system described herein, with identical arrangement of the functional units mentioned above and hereinafter, only includes the single module 4, in which a separating capillary is arranged. The separating capillary is described in more detail hereinafter. The remaining functional units, which are arranged in the embodiment having one module in or on the second module 6 and in or on the third module 8, are then arranged in or on the device 2. Additionally or alternatively, it is fundamentally also possible that the device 2 only includes two modules (namely the first module 4, in which the separating capillary is arranged, and the second module 6). The remaining functional units, which are arranged in or on the third module in the embodiment having two modules, are then arranged in or on the device 2 according to the system described herein.

As shown in FIG. 1, the device 2 according to the system described herein is designed so that the fluid 12 initially flows from the first generating device 10 to the second module 6. The fluid flow of the fluid 12 can flow in a turbulent or laminar manner out of the first generating device 10. The first generating device 10 can be, for example, a pressurized container filled with compressed air, on which a flow control valve (not shown) is arranged. In this case, the fluid 12 is compressed air. However, any other generating device 10 for generating a fluid flow of the fluid 12, which is suitable for the invention, can be used. Furthermore, any other fluid 12, which is suitable for the invention, can be used.

An influencing device 14 for influencing the fluid flow of the fluid 12 is arranged in the second module 6. The fluid 12 can flow fluidically through the influencing device 14. When the fluid 12 has flowed through the influencing device 14, the fluid flow of the fluid 12 is laminar in the embodiment described here. In the embodiment described here, the fluid flow of the fluid 12 can additionally have an inhomogeneous distribution orthogonally to the flow direction of the fluid 12 with respect to the speed. In other words, the fluid flow field of the fluid 12 in the embodiment described here is inhomogeneous after the fluid 12 has flowed through the influencing device 14. Of course, the fluid flow field of the fluid 12 can also be homogeneous in other embodiments, as described hereinafter.

As is also apparent from FIG. 1, the fluid 12 flows from the second module 6 to the first module 4. A heatable separating capillary 16 is arranged in the first module 4. The separating capillary 16 shown in FIG. 1 is very abstract. Details on the design of the separating capillary 16 are described hereinafter in the context of the detailed description of possible embodiments of the modules 4, 6, 8 of the device 2 according to the system described herein.

A material 20 or a material mixture 20, which is to be analyzed using the device 2 according to the system described herein for a gas chromatograph, in particular a temperature gradient gas chromatograph, can be applied to the separating capillary 16. For the application of the material 20 or the material mixture 20 to be analyzed to the separating capillary 16, in the embodiment of the device 2 shown in FIG. 1, a first attachment device 22 is arranged on the separating capillary 16. The first attachment device 22 is connectable, for example, to a sample dispensing device 26. The separating capillary 16 is connectable, for example, to a detection device 28 via a second attachment device 24. The connections of the sample dispensing device 26 to the first attachment device 22, the connections of the first attachment device 22 to the separating capillary 16, the connections of the separating capillary 16 to the second attachment device 24, and the connections of the second attachment device 24 to the detection device 28 are designed so that the material or the material mixture 20 to be analyzed can flow through the abovementioned connections in the mentioned sequence. In other words, the material 20 or the material mixture 20 to be analyzed can be introduced via the sample dispensing device 26 and the first attachment device 22 into the separating capillary 16, and can be discharged via the second attachment device 24 and the detection device 28 from the separating capillary 16. The sample dispensing device 26 and the detection device 28 are not part of the device 2 according to the embodiment shown. However, in other embodiments, the sample dispensing device 26 and the detection device 28 can be part of the device 2.

The separating capillary 16 is arranged in the first module 4 so that the fluid flow of the fluid 12 can flow through the separating capillary 16. For an analysis of a material 20 or material mixture 20 to be analyzed using the device 2 according to the system described herein, the separating capillary 16 can be homogeneously heated. For example, the separating capillary 16 can be connected via a conductor 18 to a power source (not shown). The separating capillary 16 is, for example, resistively heatable via the conductor 18. When the inhomogeneous fluid flow of the fluid 12 flows around the separating capillary 16, the separating capillary 16 is inhomogeneously cooled. As a result, an inhomogeneous distribution of the temperature of the separating capillary 16 can be set. An inhomogeneous distribution of the temperature of the separating capillary 16 means that the separating capillary 16 can have temperatures different from one another at different sections of the separating capillary 16. For example, the temperature of the separating capillary 16 can follow a mathematically monotonous gradient along the separating capillary 16. The inhomogeneous distribution of the temperature of the separating capillary 16 can predominantly be determined by the distribution of the speed of the inhomogeneous fluid flow of the fluid 12 at the separating capillary 16. While the fluid 12 flows around the separating capillary 16, the separating capillary 16 influences the fluid flow field of the fluid 12 only slightly or not at all, so that the fluid 12 still has an essentially linear or linear fluid flow field after flowing around the separating capillary 16.

FIG. 1 furthermore shows that the fluid 12 flows from the first module 4 to the third module 8. A second generating device 30 for generating a fluid flow is arranged in the third module 8. The second generating device 30 can enable a rapid discharge of the fluid 12 from the device 2 according to the system described herein into surroundings around the device 2 according to the system described herein. A rapid discharge means that an accumulation of the fluid 12 in the device 2 according to the system described herein can be avoided. In particular, an accumulation of the fluid 12 in the first module 4, in the second module 6, and/or in the third module 8 can be avoided. An accumulation of the fluid 12 could influence the fluid flow of the fluid 12 and thus the distribution of the temperature of the separating capillary 16. The fluid 12 discharged via the second generating device into the surroundings around the device 2 according to the system described herein can be prepared, for example. Alternatively or additionally, the fluid 12 discharged via the second generating device 30 into the surroundings around the device 2 according to the system described herein can be recycled.

FIG. 1 also shows a temperature sensor 32 and a computing unit 34. The temperature sensor 32 can be designed, for example, as a pyrometer or a thermocouple. Alternatively or additionally, the temperature sensor 32 can be any temperature sensor which is suitable for the invention. The temperature sensor 32 can measure the temperature at one point or multiple points of the separating capillary 16. In particular, the temperature sensor 32 measures the temperature in a contactless manner at one point or multiple points of the separating capillary 16. The temperature sensor 32 is connected to the computing unit 34 such that the temperature sensor 32 and the computing unit 34 can exchange items of information. The items of information can be exchanged in a wired or wireless manner. A measurement result of a temperature measurement of the temperature sensor 32 can in this respect be transmitted to the computing unit 34. The computing unit 34 can compare the measured temperature to a nominal temperature of the point or the multiple points of the separating capillary 16, at which the temperature sensor 32 has measured the temperature. As a function of a result of the above-mentioned comparison, the computing unit 34 can transmit a control signal to the controllable power source (not shown) of the conductor 18, by which a heating power of the conductor 18 can be adapted. As described at the outset, the temperature of the separating capillary 16 can be regularly varied in temperature-programmed gas chromatography, for example increased over time. If a gas chromatography analysis of a material 20 or material mixture 20 to be analyzed is carried out in a temperature-programmed manner using the device 2 according to the system described herein, the temperature can be controlled, for example, as described above. This aspect is indicated in FIG. 1 by a dashed connecting line between the computing unit 34 and the conductor 18.

The computing unit 34 can furthermore be connected to the first generating device 10 such that the first generating device 10 and the computing unit 34 can exchange items of information. The speed of the fluid flow of the fluid 12 generated by the first generating device 10 can thus be controlled in a computer-assisted manner. If needed, a higher or a lower speed of the fluid flow of the fluid 12 than a current flow speed can thus be set. For example, a temperature gradient of the separating capillary 16 can be set flexibly by a combination of the control of the power source of the conductor 18 and the control of the first generating device 10.

The computing unit 34 can furthermore be connected to the second generating device 30 such that the second generating device 30 and the computing unit 34 can exchange items of information. The second generating device 30 can thus be controlled in the same manner by the computing unit 34 as the first generating device 10. If desired, it can be ensured in this way, for example, that the volume flow with which the fluid flow of the fluid 12 flows out of the third module 8 approximately corresponds to the volume flow with which the fluid flow of the fluid 12 flows into the first module 4.

The computing unit 34 can furthermore be connected to the sample dispensing device 26, to which the first attachment device 22 is connectable, such that the sample dispensing device 26 and the computing unit 34 can exchange items of information. Alternatively or additionally, the computing unit 34 can be connected to the detection device 28, to which the second attachment device 24 is connectable, such that the detection device 28 and the computing unit 34 can exchange items of information. The speed at which the material 20 or the material mixture 20 to be analyzed is dispensed into the separating capillary 16 can thus be controlled. Additionally or alternatively, the detection device 28 can transmit items of information to the computing unit 34, so that the computing unit 34 can evaluate the items of information of the detection device 28.

The device 2 according to the invention is not restricted to the above-described embodiment. In particular, the third module 8 and the second generating device 30 are not absolutely required for the device 2 according to the invention. Additionally or alternatively, the first generating device 10, the first module 4, the second module 6, and/or the third module 8 can be arranged in a different way than described above. Any arrangement of the first generating device 10, the first module 4, the second module 6, and/or the third module 8 can be used which is suitable for the invention. Additionally or alternatively, the device 2 according to the system described herein can include an additional module or a plurality of additional modules (not shown). For example, the device 2 according to the system described herein can include an additional module or a plurality of additional modules which technically correspond to the first module 4. The additional module/plurality of additional modules can be arranged, for example, precisely like the first module 4 in the flow direction of the fluid flow of the fluid 12 between the second module 6 and the third module 8.

FIG. 2 shows an embodiment of the device 2 according to the system described herein in a side view, in which the first module 4, the second module 6, and the third module 8 are arranged one above another in a receptacle device 36. The side view of the device 2 according to the system described herein corresponds, for example, to the view of the device 2 according to the system described herein which an operator can obtain when operating the device 2 according to the system described herein.

In the embodiment of the device 2 according to the system described herein shown in FIG. 2, the first module 4, the second module 6, and the third module 8 are each designed so that each of the abovementioned modules 4, 6, 8 includes an at least partially closed housing. A first housing 40 of the first module 4 corresponds to the technical implementation of the delimitation of the first module 4 shown in FIG. 1. A second housing 42 of the second module 6 corresponds to the technical implementation of the delimitation of the second module 6 shown in FIG. 1. A third housing 44 of the third module 4 corresponds to the technical implementation of the delimitation of the third module 8 shown in FIG. 1. In other words, the first housing 40 of the first module 4, the second housing 42 of the second module 6, and the third housing 44 of the third module 8 each accommodate the technical features which are shown within the respective rectangles in FIG. 1.

The first housing 40 of the first module 4, the second housing 42 of the second module 6, and the third housing 44 of the third module 8 are each designed in the form of a cassette in the embodiment of the device 2 according to the system shown in FIG. 2. A cassette in this context is an essentially cubical, thin-walled body or a cubical, thin-walled body. An essentially cubical, thin-walled body or a cubical, thin-walled body generally has six thin-walled sides which enclose a cubical cavity. For example, a hollow cube is a cubical, thin-walled body. The technical features of the first module 4 are accommodated in the cavity of the cassettes of the first module 4. The technical features of the second module 6 are accommodated in the cavity of the cassettes of the second module 6. The technical features of the third module 8 are accommodated in the cavity of the cassettes of the third module 8. In practice, the housings 40, 42, 44 of the abovementioned modules 4, 6, 8 can also be designed in other forms than in the form of a cubical cassette in each case, for example, in the form of cylinders in each case. Alternatively, the abovementioned modules 4, 6, 8 can also be designed without housings. For example, a framework can be used instead of a housing.

As already mentioned, the first module 4, the second module 6, and the third module 8 are arranged one over another in the receptacle device 36 in the embodiment of the device 2 according to the system shown in FIG. 2. The receptacle device 36 is designed as a receptacle framework in the embodiment of the device 2 according to the system shown in FIG. 2. The receptacle device 36 in the form of the receptacle framework includes a plurality of guide rails 38, into which the first module 4, the second module 6, and the third module 8 are insertable. The abovementioned modules 4, 6, 8 can be arranged manually, for example, by the operator of the device 2 according to the system described herein, who inserts the first module 4 and/or the second module 6 and/or the third module 8 on the guide rails 38 into the receptacle device 36 in the form of the receptacle framework of the embodiment shown of the device 2 according to the system described herein. The insertion can take place, for example, in the direction of the side view shown of the device 2 according to the system described herein. The direction of the side view of the device 2 according to the system described herein corresponds to the direction of the y axis in the Cartesian coordinate system shown in FIG. 2. The operator of the device 2 according to the system described herein can insert the first module 4 and/or the second module 6 and/or the third module 8, for example, into the receptacle device 36 until the respective module 4, 6, 8, which the operator inserts, is arranged abutting with the receptacle device 36 in the receptacle device 36. When all modules, i.e., the first module 4, the second module 6, and the third module 8, are arranged abutting with the receptacle device 36, the abovementioned modules 4, 6, 8 are arranged properly. The device 2 according to the system described herein is then fundamentally ready for use. The meaning of the expression used above of proper arrangement of the mentioned modules 4, 6, 8 is maintained hereinafter.

When the first module 4, the second module 6, and the third module 8 are arranged properly, the abovementioned modules 4, 6, 8 are in this respect arranged one over another in the receptacle device 36 in the embodiment described here of the device 2. The first module 4 is arranged directly above the second module 6 and the third module 8 is arranged directly above the first module 4. Alternatively, predefined spacings in a vertical direction can be configured between the abovementioned modules 4 and 6 and 4 and 8. The vertical direction corresponds in FIG. 2 to the direction of the z axis of the Cartesian coordinate system shown in FIG. 2. When spacings are provided between the abovementioned modules 4, 6, 8, the device 2 can then include seals (not shown), for example, which are arranged circumferentially around the abovementioned modules at the areas between two adjacent modules 4 and 6 and 4 and 8. An undesired outflow of the fluid 12 can thus be avoided, so that the fluid flow of the fluid 12 can flow at least essentially linearly or linearly from the second module 6 into the first module 4 and into the third module 8. If the receptacle device 36 includes the guide rails 38, the spacings of the guide rails 38 from one another are adapted to the shapes of the housings 40, 42, 44 of the first module 4, the second module 6, and the third module 8 and to the possibly predefined spacings between the abovementioned modules 4, 6, 8, so that each of the abovementioned modules 4, 6, 8 can only be arranged properly in the receptacle device 36 in a position provided for the respective module.

In particular, the first module 4, the second module 6, and the third module 8 can be arranged one over another in a proper arrangement in the receptacle device 36 such that the first housing 40 of the first module 4, the second housing 42 of the second module 6, and the third housing 44 of the third module 8 are arranged congruently in a top view of the device 2 according to the system described herein. In other words, the first housing 40 of the first module 4, the second housing 42 of the second module 6, and the third housing 44 of the third module 8 have an identical base surface 46. The base surface 46 of a module of the abovementioned set of the modules 4, 6, 8 is the side of the housing of a module which faces downward in the side view. In other words, the base surface 46 of a module of the abovementioned side of the modules 4, 6, 8 is the side of the housing of a module which faces counter to the direction of the z axis shown in FIG. 2. Alternatively, the first housing 40 of the first module 4, the second housing 42 of the second module 6, and the third housing 44 of the third module 8 can also have differently formed base surfaces 46.

The embodiment of the device 2 according to FIG. 2 furthermore shows that the first generating device 10 is arranged laterally on the second module 6 and introduces the fluid 12 laterally into the second module 6. For this purpose, the second housing 42 of the second module 6 has, for example, a passage 48, which is lateral in the side view and through which fluid can flow. The fluid 12 can be conducted into the second module 6 from the first generating device 10 via the passage 48. Alternatively, the passage 48, via which the fluid 12 can be conducted into the second module 6, can be introduced on any other side of the second housing 42 of the second module 6. Furthermore, a plurality of passages 48 can alternatively or additionally be introduced into the second housing 42 of the second module 6.

Furthermore, FIG. 2 shows that at least one opening 50A, 50B, through which fluid can flow, is provided in each case in the sides of the first housing 40 of the first module 4 which faces toward the second module 6 and the third module 8. The second housing 42 of the second module 6 also includes at least one opening 50B through which fluid can flow in the side which faces toward the first module 4. The third housing 44 of the third module 8 also includes at least one opening 50A through which fluid can flow in the side which faces toward the first module 4. For example, the abovementioned openings 50A, 50B are arranged in the housings 40, 42, 44 of the first module 4, the second module 6, and the third module 8 such that the fluid flow of the fluid 12 can flow essentially linearly or linearly from the second module 6 through the first module 4 into the third module 8 with proper arrangement of the first module 4, the second module 6, and the third module 8 in the receptacle device 36.

The third module 8 shown in FIG. 2 furthermore includes a passage 52 through which fluid can flow. The passage 52 through which fluid can flow is arranged, for example, in a side view of the device 2 according to the system described herein, in an upper side of the third housing 44 of the third module 8. The upper side of the third housing 44 of the third module 8 faces in the direction of the z axis of the Cartesian coordinate system shown in FIG. 2. The fluid flow of the fluid 12 which flows from the first module 4 into the third module 8 can exit, for example, from the third module 8 via the passage 52 in the third housing 44 of the third module 8.

If alternatively vertical spacings are introduced between the first module 4 and the second module 6, the openings 50A, 50B in the housings 40, 42 of the abovementioned modules 4, 6 can be connected to mechanical connecting devices (not shown). If alternatively vertical spacings are introduced between the first module 4 and the third module 8, the openings 50A, 50B in the housings 40, 44 of the abovementioned modules 4, 8 can also be connected to mechanical connecting devices (not shown).

As described above, the first module 4 and/or the second module 6 and/or the third module 8 are removable from and insertable into the receptacle device 36. For example, the abovementioned modules 4, 6, 8 can be removed on the guide rails 38 from the receptacle device 36 and/or inserted into the receptacle device 36. The device 2 according to the system described herein is characterized in particular in that the insertion of the first module 4 and/or the second module 6 by the operator into the receptacle device 36 in the proper arrangement automatically establishes a connection between the first module 4 and the second module 6 via the openings 50A, 50B in the housings 40, 42. Furthermore, the device 2 according to the system described herein is in particular characterized in that the insertion of the first module 4 and/or the third module 8 by the operator into the receptacle device 36 in the proper arrangement automatically establishes a connection between the first module 4 and the third module 8 via the openings 50A, 50B in the housings 40, 44. Furthermore, the device 2 can be characterized, for example, in that due to the insertion of the first module 4 in the proper arrangement, a connection can automatically be established between the first module 4 and the sample dispensing device 26 via the first attachment device 22 and between the first module 4 and the detection device 28 via the second attachment device 24. Alternatively, the connection of the first module 4 to the sample dispensing device 26 at the first attachment device 22 and to the detection device 28 at the second attachment device 24 can be established manually, for example.

The first module 4, the second module 6, and the third module 8 are described in detail hereinafter.

An embodiment of the first module 4 is shown in FIGS. 3 and 4. FIG. 3 shows the embodiment of the first module 4 having the separating capillary 16 arranged in the first module 4 in a top view. FIG. 4 shows the embodiment of the first module 4 having the separating capillary 16 arranged in the first module 4 in a cross-sectional view. The separating capillary 16 is designed essentially as a planar spiral in the embodiment of FIG. 4.

The first housing 40 of the first module 4 is designed so that the first housing 40 includes an essentially cubical spatial content. For a cubical spatial content, the first housing 40 of the first module 4 does not have to be a closed cubic body. It is sufficient if the volume of a closed lateral surface which is formed around the first housing 40 is cubical. In this context, the first housing 40 of the first module 4 in particular includes the planar, rectangular base surface 46, as shown by the top view of the first module 4 in FIG. 3. Furthermore, the first housing 40 of the first module 4 has an essentially rectangular cross section, as shown by the cross-sectional view in FIG. 4. The rectangular cross section of the first module 4 results from a lateral surface which can be formed around the first housing 40 of the first module 4 in the cross-sectional view in FIG. 4. In other words, the first housing 40 of the first module 4 is a thin-walled, cubic body, the upper and lower side of which (that is to say the sides in the direction of the z axis and counter to the direction of the z axis of the Cartesian coordinate system in FIG. 4) are at least partially removed. Alternatively, the first housing 40 of the first module 4 can have any other shape which is suitable for the invention.

FIG. 3 and FIG. 4 furthermore show that the separating capillary 16 essentially formed as a planar spiral is also arranged in the first module 4. In other words, the separating capillary 16 is formed flatly by winding the separating capillary 16 around a point in a plane with increasing radius. The point around which the separating capillary 16 is wound is the center point 54 of the separating capillary 16. The separating capillary 16 is arranged in the embodiment of the first module 4 shown in FIG. 3 and FIG. 4 so that the plane in which the separating capillary 16 is wound is parallel to the base surface 46 of the first module 4. Furthermore, the separating capillary 16 is arranged in the embodiment of the first module 4 shown in FIG. 3 and FIG. 4 so that the center point 54 of the separating capillary 16 corresponds to a center of gravity of the base surface 46 of the first module 4.

The arrangement of the separating capillary 16 in the first module 4 in the above-described position can be implemented, for example, in that the separating capillary 16 is accommodated in a holding device 56. The holding device 56 can in particular be formed from a temperature-resistant material having low thermal conductivity, for example a plastic or a ceramic. A suitable plastic can be, for example, polyimide, however, any material which is suitable for the invention can be used for the holding device 56. The holding device 56 can be formed, for example, as a mechanically stable, thin-walled, and oblong plate made of a suitable material having recesses. Alternatively, the holding device 56 can be formed as a plurality of mechanically stable, thin-walled, and oblong plates made of a suitable material having recesses. The separating capillary 16 can then be accommodated in the recesses of the plate or the plurality of plates, for example in punctiform contact, as shown in FIGS. 4 and 5. The holding device 56 can be fixed, for example, on the first housing 40 of the first module 4. The fixation can be carried out, for example, by a materially bonded and/or a form-fitting and/or a friction-locked connection of the holding device 56 to the first housing 40.

Alternatively or additionally, any other holding device which is suitable for accommodating the separating capillary 16 can be used as the holding device 56. In addition to the temperature resistance and the low thermal conductivity, the holding device 56 can in particular have a low heat capacity with respect to a volume required for its functionality. For example, the volume-based heat capacity can be less than 3.8 J/cm³K. Furthermore, the holding device 56 can be arranged in particular in the opening 50B, through which fluid can flow, in the first housing 40 of the first module 4. The arrangement of the holding device 56 and the separating capillary 16 in the first module 4 can then be implemented, for example, on the side of the first housing 40 of the first module 4 which faces toward the second module 6. The separating capillary 16 can alternatively be arranged in any other arbitrary position and/or orientation in the first module 4 which is suitable for the system described herein. For a robust design of the first module 4, for example, the separating capillary 16 can be fixed in the holding device 56 and/or the housing 40 of the first module 4. The fixation can be carried out, for example, by a materially bonded and/or a form-fitting and/or a friction-locked connection of the separating capillary 16 to the holding device 56 and/or the first housing 40. The fixation is designed in particular such that the heat transfer between the separating capillary 16 and the holding device 56 is minor, for example, in that there is only a punctiform contact to the separating capillary 16 or thermal insulation is provided.

The essentially spiral-shaped separating capillary 16 shown in FIGS. 3 and 4 includes two linearly formed end sections. A first end section 58 extends the separating capillary 16 from an inner radius of the separating capillary 16 close to a center point 54 of the separating capillary 16 radially outward beyond the separating capillary 16. For this purpose, the first end section 58 can be formed partially curved. The first end section 58 penetrates the first housing 40 of the first module 4 and opens into the first attachment device 22, which is used to attach the separating capillary 16 to the sample dispensing device (not shown). A second end section 60 extends the separating capillary 16 outward from an outer radius of the separating capillary 16, for example in parallel to the first end section 58. The second end section 60 penetrates the first housing 40 of the first module 4 and opens into the second attachment device 24, which is used to attach the separating capillary 16 to the detection device (not shown). A thermally insulating material 62 is arranged around the first end section 58 and the second end section 60 of the separating capillary 16. It can be ensured by the arrangement of the thermally insulating material 62 that a predefined temperature can be set in the first end section 58 and in the second end section 60 of the separating capillary 16, which is greater than the temperature at any point of the separating capillary 16 between the end sections.

In the described embodiment of the first module 4, a flow director device 64 is additionally arranged for setting a homogeneous flow direction of the fluid flow of the fluid 12 at the separating capillary 16. The arrangement of the flow director device 64 along the separating capillary 16 is shown in detail in FIG. 5. The flow director device 64 is designed as a band. A band in this context is a planar, solid formation which is longer in a first extension direction than in a second extension direction. A thin-walled plastic strip can be an example of a band. If the flow director device 64 is designed, for example, as a thin-walled plastic strip, the band can be arranged spaced apart in parallel along the separating capillary 16 in the first extension direction of the band. The second extension direction of the band can point here, for example, in the direction in which the flow director device 64 is supposed to align the fluid flow of the fluid 12. In FIG. 5, the direction in which the flow director device 64 is supposed to align the fluid flow of the fluid 12 corresponds to the direction of the z axis of the Cartesian coordinate system shown.

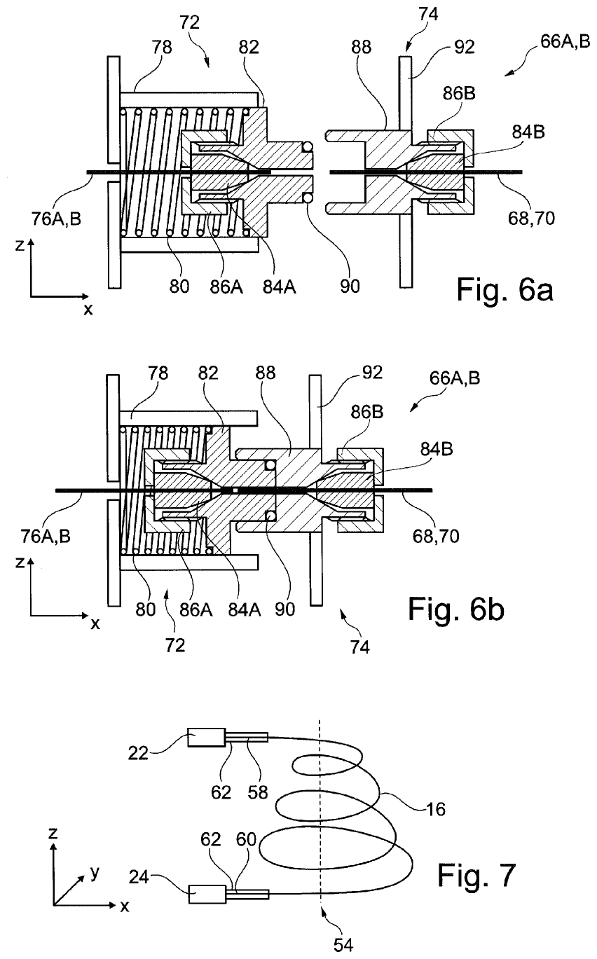

FIGS. 6a and 6b show an exemplary embodiment of quick connecting devices 66A, 66B of the attachment devices 22, 24 in the longitudinal section. Identical components of FIGS. 6a and 6b are provided with identical reference signs as already mentioned above. FIG. 6a shows the quick connecting devices 66A, 66B in an open state. FIG. 6b shows the quick connecting devices 66A, 66B in a closed state. For example, a first quick connecting device 66A of the type shown can be arranged at the first end 68 of the separating capillary 16 and a second quick connecting device 66B of the type shown can be arranged at the second end 70 of the separating capillary 16. Therefore, for example, a first quick connecting device 66A of the type shown can be used to connect the separating capillary 16 to the sample dispensing device 26. Furthermore, for example, a second quick connecting device 66B of the type shown can be used to connect the separating capillary 16 to the detection device 28.

The embodiment shown of the quick connecting devices 66A, 66B includes a first connector section 72 and a second connector section 74. The second connector section 74 can be pushed onto the first connector section 72. The first connector section 72 can be fluidically connected to the sample dispensing device 26, for example, via a first transfer line 76A. Alternatively, the first connector section 72 can be fluidically connected to the detection device 28, for example, via a second transfer line 76B. The first connector section 72 can furthermore be fixed on the device 2, in particular on the receptacle device 36. The second connector section 74 can be fluidically connected to the first end 68 of the separating capillary 16. Alternatively, the second connector section 74 can be fluidically connected to the second end 70 of the separating capillary 16. The second connector section 74 can furthermore be fixed on the first module 4, the second module 6, or the third module 8. The first connector section 72 is fixed on the device 2 such that the second connector section 74 can be pushed onto the first connector section 72 when one of the abovementioned modules 4, 6, 8, on which the second connector section 74 is arranged, is inserted into the receptacle device 36. In this case, a connection of the separating capillary 16 to the sample dispensing device 26 and/or to the detection device 28 is automatically established.

For a gas-tight connection, which can be automatically established, of the separating capillary 16 to the sample dispensing device 26 and/or to the detection device 28, the first connector section 72 includes a connector housing 78. The connector housing 78 can accommodate a compression spring 80, for example. The compression spring 80 can be compressed in the connector housing 78 via a first end cap 82, which is mounted in an insertable manner in the connector housing 78. The transfer line 76A or 76B, which is fluidically connected to the sample dispensing device 26 or the detection device 28, can be led axially through the connector housing 78 and the compression spring 80 and can open into a first sealing body 84A, for example a first ferrule. The sealing body 84A can be inserted into the first end cap 82. Furthermore, a first union nut 86A can be arranged around the transfer line 76A or 76B, onto which the first end cap 82 can be screwed, so that the first sealing body 84A is pressed between the first union nut 86A and the first end cap 82. As a result, the transfer line 76A or 76B is connected in a gas-tight manner to the first end cap 82 and the first end cap 82 can be pressed into the connector housing 78 against the compression spring 80.

The second connector section 74 includes a second end cap 88. The second end cap 88 is formed complementarily to the first end cap 82. In the same way as described above, the first end 68 or the second end 70 of the separating capillary 16 is arranged in the second end cap 88 using a second sealing body 84B, for example a second ferrule, and a second union nut 86B. A small part of the first end 68 or second end 70 of the separating capillary 16 arranged in the second end cap 88 protrudes out of the second end cap 88 in the direction in which the second end cap 88 can be pushed onto the first end cap 82. In FIGS. 6a and 6b, the direction corresponds to the x axis of the Cartesian coordinate system. The abovementioned small part of the first end 68 or the second end 70 of the separating capillary 16 can thus be pushed into the first end cap 82 when the second connector section 74 is pushed onto the first connector section 72.

When the second connector section 74 is pushed onto the first connector section 72, the compression spring 80 presses the first end cap 82 into the second end cap 88 against the connector housing 78. The force of the compression spring 80 generates a secure seat of the first end cap 82 in the second end cap 88, without pressing the module 4, 6, 8, on which the second connector section 74 is arranged, out of the receptacle device 36.

A gas-tight connection between the first connector section 72 and the second connector section 74 can be achieved in particular in that, for example, an O-ring 90 is arranged between the first end cap 82 and the complementary second end cap 88. Furthermore, the first end cap 82 and the second end cap 88 can be pressed into the connector housing 78 while the module 4, 6, 8, on which the second connector section 74 is arranged, is inserted into the receptacle device 36. With proper arrangement of the module 4, 6, 8, on which the second connector section 74 is arranged, in the receptacle device 36, a connector cover plate 92 arranged radially around the second end cap 88 can close the connector housing 78 of the first connector section 72 (cf. FIG. 6b).

Additionally or alternatively, connectors of the above-described type can be used in order to automatically fluidically connect the separating capillary 16 to a further unit, for example a second separating capillary (not shown). This can be applied, for example, in a device 2 for a multidimensional gas chromatograph (not shown).

Due to the above-described design of the first module 4, the first module 4 is removable as an entire unit by the operator of the device 2 according to the system described herein from the receptacle device 36 and is insertable into the receptacle device 36. The removal and the insertion do not require the operator to come into contact with the sensitive separating capillary 16.

The design of the first module 4 and in particular the design of the separating capillary 16 is/are not restricted to the preceding embodiments. For example, the separating capillary 16 can be formed, not as a planar spiral, but rather as a three-dimensional spiral. An example of the separating capillary 16 which is formed as a three-dimensional spiral, in particular as a conical spiral, is shown in FIG. 7. Identical components of FIG. 7 are provided with identical reference signs as already mentioned above.

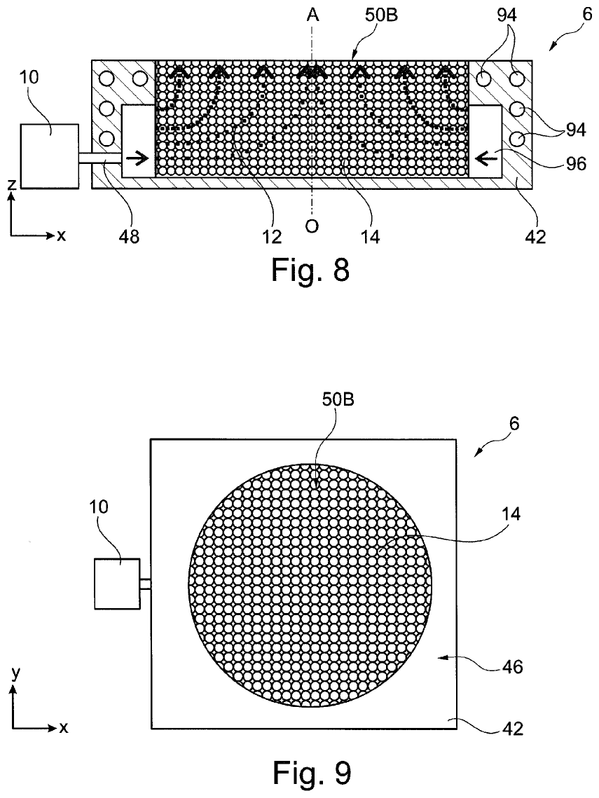

FIG. 8 shows a possible embodiment of the second module 6 having the influencing device 14 arranged in the second module 6 for influencing the fluid flow of the fluid 12 in a cross-sectional view. Identical components of FIG. 8 are provided with identical reference signs as already mentioned above. FIG. 9 shows the second module 6 shown in FIG. 8 in a top view. Identical components are also provided with identical reference signs in FIG. 9 as mentioned above.

The second housing 42 of the second module 6 is designed so that the second housing 42 includes an essentially cubical spatial content. For a cubical spatial content, the second housing 42 of the second module 6 does not have to be a closed cubical body. It is sufficient if the volume of a closed lateral surface, which is formed around the second housing 42, is cubical. The second module 6 can to this extent, for example, like the above-described first module 4, have an essentially rectangular cross section and a rectangular base surface 46, as shown in FIGS. 8 and 9. The rectangular cross section of the second module 6 can result from a lateral surface which can be formed around the second housing 42 of the second module 6 in the cross-sectional view in FIG. 8. In particular, the second housing 42 of the second module 6 can essentially have the form of a rectangular U-profile in cross section. The cross section shown in FIG. 8 is formed at a center plane of the second module 6. It is apparent on the basis of the top view of the second module 6 shown in FIG. 9 that the upper opening of the profile which is U-shaped in cross section is round. This opening can then be the opening 50B in the second housing 42 of the second module 6. In other words, the second housing 42 of the second module 6 is a thin-walled, cubical body, the upper side of which (i.e., the side in the direction of the z axis of the Cartesian coordinate system in FIG. 8) was at least partially removed. Alternatively, the second housing 42 of the second module 6 can in practice have any other form which is suitable for the system described herein.

As described above, the second housing 42 of the second module 6 includes the passage 48 through which fluid can flow. The passage 48 can lead laterally through the second housing 42, for example. The first generating device 10 for generating a fluid flow of the fluid 12 can be attached to this passage 48 from outside the second housing 42 of the second module 6.

Furthermore, a cooling device 94 for cooling the second module 6 can be integrated in the second housing 42 of the second module 6. The cooling device 94 can include, for example, a fitting for a cooling water circuit and a plurality of cooling channels. The cooling channels are in particular arranged in the second housing 42 of the second module 6 such that heat which is emitted by the separating capillary 16 is absorbed by the cooling device 94. In particular, the cooling channels can be introduced into the second housing 42 of the second module 6 on a side which is close to the first module 4 upon proper arrangement of the first module 4 and the second module 6 in the receptacle device 36.

FIGS. 8 and 9 furthermore show that the influencing device 14 for influencing the fluid flow of the fluid 12 is arranged in the second module 6. The influencing device 14 is designed as a sponge structure through which fluid can flow. The sponge structure thus has open porosity. The size of the pores is identical or essentially identical over the entire sponge structure. In the embodiment of the second module 6 shown in FIG. 8, the influencing device 14 designed as a sponge structure has, for example, a cylindrical shape having rectangular cross section. In a top view, the influencing device 14 can also be round, as shown in FIG. 9, following the form of the opening 50B, for example. The influencing device 14 occupies a large fraction of the cavity in the second housing 42 of the second module 6. For example, the influencing device 14 is arranged in the second housing 42 of the second module 6 such that the influencing device 14 designed as a sponge structure nearly completely fills the second housing 42, which is designed in cross section essentially as a right-angled U-profile. The influencing device 14 designed as a sponge structure can extend, for example, to the upper edge of the second module 6 and can terminate flush there with the second housing 42 of the second module 6.

According to the embodiment of the second module 6, a ring channel 96 (not shown in FIG. 9) is arranged in the second housing 42 of the second module 6 partially or completely around the influencing device 14 designed, for example, as a sponge structure having a round shape in a top view. The ring channel 96 is in particular arranged horizontally around the influencing device 14 designed as a sponge structure. The ring channel 96 is connected to the passage 48 in the second housing 42 of the second module 6. On the side of the ring channel 96 which faces toward the influencing device 14 designed as a sponge structure, the ring channel 96 is at least partially open. The fluid 12 can thus pass from the generating device via the passage 48 in the second housing 42 of the second module 6 into the ring channel 96. Starting from the ring channel 96, the fluid 12, in a top view of the second module 6, for example, can flow radially into the influencing device 14 designed as a sponge structure and can flow out of the opening 50B in the housing 42 of the second module 6 to the first module 4.

The flow speed of the fluid 12 can be deliberately influenced by a special embodiment of the influencing device 14 designed as a sponge structure. In this embodiment of the second module 6, the influencing device 14 designed as a sponge structure can be, for example, a sponge structure having homogeneous permeability for the fluid 12. In this case, the flow speed of the fluid flow of the fluid 12 is inhomogeneously influenced in that the fluid 12 covers different path lengths through the influencing device 14 designed as a sponge structure from the ring channel 96 to an exit from the influencing device 14 through the opening 50B as a function of the exact entry point. If the fluid 12 covers a long path length through the influencing device 14, the speed of the fluid 12 is reduced more strongly than if the fluid 12 covers a short path length through the influencing device 14. This relationship is reflected in FIG. 8 by the dotted arrows. Arrows having a short distance between the dots indicate in this figure and hereinafter a short path length and a high flow speed of the fluid flow of the fluid 12. Arrows having a long distance between the dots indicate in this figure and hereinafter a long path length and a low flow speed of the fluid flow of the fluid 12. The influencing device 14 designed as a sponge structure is centrally-symmetrical in this embodiment and in the embodiments described hereinafter around the vertical center axis O-A. The fluid flow field flowing out of the second module 6 in the direction of the first module 4 (i.e., in the direction of the z axis of the Cartesian coordinate system shown in FIG. 8) is in this respect also centrally-symmetrical inhomogeneous with respect to the flow speed of the fluid 12.

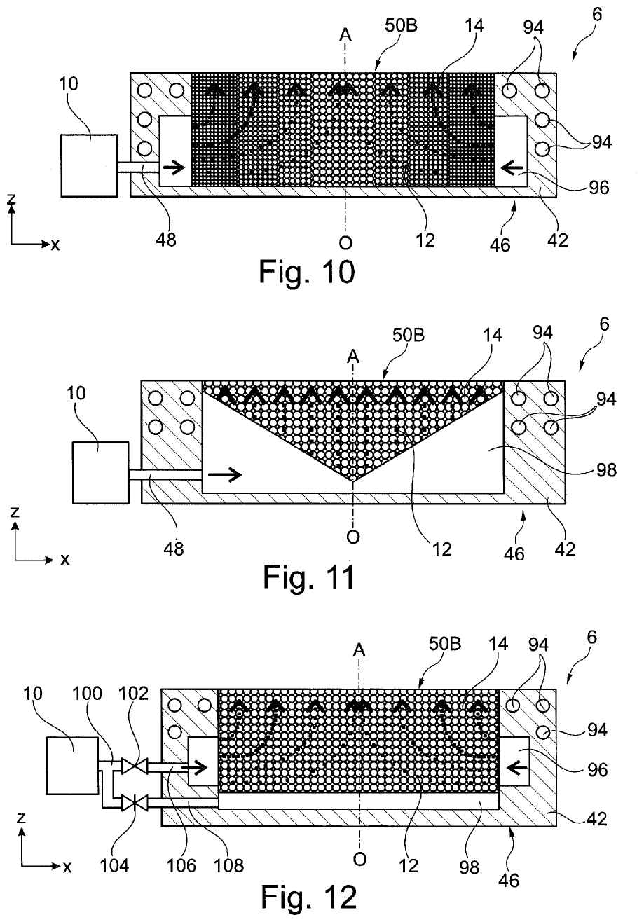

In a further embodiment of the second module 6, the influencing device 14 is alternatively or additionally also designed as a sponge structure having inhomogeneous permeability for the fluid 12. As shown in FIG. 10, in this case the size of the pores decreases, for example, from a center of the influencing device 14 designed as a sponge structure toward the ring channel 96. In this case, the distribution of the flow speed of the fluid flow of the fluid 12 is (additionally) inhomogeneously influenced in that the fluid flow of the fluid 12 is decelerated by a locally low permeability of the sponge structure.

FIG. 11 shows a further possible embodiment of the second module 6. The further embodiment of the second module 6 essentially corresponds to the embodiment of the second module 6 according to FIG. 8, where the following features distinguish the further embodiment of the second module 6 from the embodiment according to FIG. 8:

A ring channel in the second housing 42 of the second module 6 is not provided in the further embodiment of the second module 6. Furthermore, the influencing device 14 designed as a sponge structure can be designed as a cone, for example, so that the cone has a triangular cross section in the cross-sectional view of the second module 6. The influencing device 14, which is triangular in the cross-sectional view of the second module 6, can in particular be arranged in the cavity of the second housing 42 of the second module 6 such that the influencing device 14 designed as a sponge structure terminates flush with the upper edge of the second module 6, which faces toward the first module 4. The influencing device 14, which is triangular in cross section and is designed as a sponge structure, then points with the tip of the triangle shape in the direction of the side of the second module 6 which, upon proper arrangement of the first module 4 and the second module 6 in the receptacle device 36, faces away from the first module 4. A free volume 98 through which fluid can flow is thus arranged in the second module 6 below the influencing device 14, which is triangular in cross section, for influencing the fluid flow of the fluid 12. The fluid flow of the fluid 12 can thus pass from the generating device 10 via the passage 48 into the free volume 98. From the free volume 98, the fluid 12 can flow into the influencing device 14, designed as a sponge structure, for influencing the fluid flow of the fluid 12 and can flow out of the opening 50B in the second housing 42 of the second module 6 to the first module 4. By way of the described embodiment of the second module 6, the fluid flow of the fluid 12 can be influenced in the same way as in the embodiment of the second module 6 according to FIG. 8. Due to the different form of the influencing device 14 designed as a structure in the embodiment of the second module 6 according to FIG. 8 and in the further embodiment of the second module 6 according to FIG. 11, the fluid flow field of the fluid 12 can have a different speed distribution after leaving the influencing device 14. Additionally or alternatively, the above embodiments of the second module 6 can be combined with one another.

FIGS. 12 and 13 show still a further possible embodiment of the second module 6. The embodiment of the second module 6 according to FIGS. 12 and 13 essentially corresponds to the embodiment of the second module 6 according to FIG. 8, where the following features distinguish the embodiment of the second module 6 according to FIGS. 12 and 13 from the embodiment according to FIG. 8:

A distributor device for distributing the generated fluid flow of the fluid 12 is arranged between the first generating device 10 and the passage 48 through the second housing 42 of the second module 6. The distributor device can include, for example, a pipeline system having a forked part 100. The distributor device can furthermore include, for example, a first valve 102 and a second valve 104. The first valve 102 can be arranged on a first section of the forked part 100. The second valve 104 can be arranged on a second section of the forked part 100. A first pipe section 106 leads to the second module 6 from the first section of the forked part 100. A second pipe section 108 leads to the second module 6 from the second section of the forked part 100. The first pipe section 106 and the second pipe section 108 can be guided through the second housing 42 of the second module 6 lying one on top of another. In this case the first pipe section 106 opens into the ring channel 96, which is designed in the same manner as in the embodiment of the second module 6 according to FIG. 8. The second pipe section 108 opens into the free volume 98, through which fluid can flow, in the second housing 42 of the second module 6. The free volume 98 can in particular be arranged over the full area below the influencing device 14 in the second housing 42 of the second module 6. The influencing device 14 and the free volume 98 arranged underneath can have any shape which is suitable for the system described herein. When the second valve 104 is blocked, the fluid 12 can then pass from the generating device via the first pipe section 106 into the ring channel 96. From the ring channel 96, the fluid 12 can flow laterally into the sponge structure of the influencing device 14 and can flow out of the opening 50B in the second housing 42 of the second module 6 to the first module 4. When the first valve 102 is blocked, the fluid 12 can pass from the generating device 10 via the second pipe section 108 into the free volume 98. From the free volume 98, the fluid 12 can flow over the full area from below into the sponge structure of the influencing device 14 and can flow out of the opening 50B in the second housing 42 of the second module 6 to the first module 4. Due to a flow of the fluid 12 into the influencing device 14 from different sides, the fluid flow of the fluid 12 after the exit of the fluid 12 from the influencing device 14 can have different distributions of the flow speed. The flexibility of the device 2 according to the system described herein is thus increased. In particular, either a homogeneous fluid flow of the fluid 12 or alternatively an inhomogeneous fluid flow of the fluid 12 can be generated by the embodiment shown in FIGS. 12 and 13, having the ring channel 96 and the free volume 98 arranged over the full area below the influencing device 14 in the second housing 42 of the second module 6.

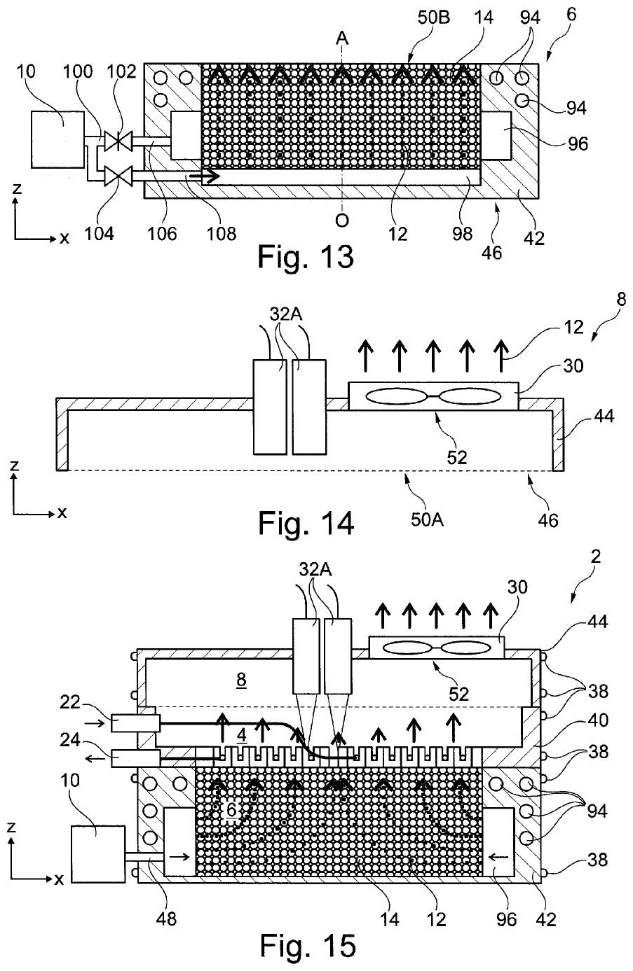

FIG. 14 shows an embodiment of the third module 8 of the device 2 according to the system described herein. The third module 8 is also designed so that it includes an essentially cubical spatial content. The third housing 44 of the third module 8 can in this respect, for example, like the above-described second module 6, include a rectangular base surface 46 and a substantially rectangular cross section. Alternatively, the third housing 44 of the third module 8 can in practice have any other shape which is suitable for the system described herein. For example, the third housing 44 of the third module 8 can be a rectangular planar plate.

As described above, the third housing 44 of the third module 8 includes a passage 52 through which fluid can flow. The passage 52 can be oriented, for example, in the flow direction of the fluid flow of the fluid 12. In other words, the passage 52 can lead through the third housing 44 of the third module 8 in the direction of the z axis of the Cartesian coordinate system shown in FIG. 14. The fluid flow of the fluid 12, which flows from the first module 4 into the third module 8, can escape from the third module 8 through the passage 52. At the passage 52, the third module 8 can furthermore include the second generating device 30 for generating a fluid flow. The second generating device 30 is designed, for example, as a fan in the embodiment of the third module 8 shown in FIG. 14. In addition, a further temperature sensor 32A is arranged in the third module 8. The temperature sensor 32A is designed, for example, as a pyrometer. With proper arrangement of the first module 4 and the third module 8 in the receptacle device 36, the pyrometer can measure the temperature of a predefined point of the separating capillary 16 in a contactless manner.

FIG. 15 shows an embodiment of the first module 4, an embodiment of the second module 6, and an embodiment of the third module 8 arranged properly one over another in the receptacle device 36 in a cross-sectional view. In particular, the path on which the fluid flow of the fluid 12 flows through the device 2 according to the system described herein is apparent. The fluid 12 flows from the first generating device 10 in the passage 48 in the second housing 42 of the second module 6, then in the ring channel 96, then in the influencing device 14, then past the separating capillary 16, then in the third module 8, and then via the passage 52 into the surroundings of the device 2 according to the system described herein.

As described above, the first module 4 and/or the second module 6 and/or the third module 8 are removable from and insertable into the receptacle device 36. The removal and/or the insertion can take place in the embodiment of the device 2 according to the system described herein shown in FIG. 15 in particular orthogonally to the direction in which the abovementioned modules 4, 6, 8 are arranged one over another. For example, the abovementioned modules 4, 6, 8 can be removed from the receptacle device 36 and/or inserted into the receptacle device 36 in the direction of the y axis or in the direction of the x axis of the Cartesian coordinate system shown in FIG. 15. By way of an insertion of the first module 4 and/or the second module 6 and/or the third module 8 in one of the directions, a connection is automatically established between the abovementioned modules 4, 6, 8 via the openings 50A, B. In addition, after an insertion of the first module 4 in the direction of the y axis or the x axis of the Cartesian coordinate system shown in FIG. 15, a connection of the first attachment device 22 to the sample dispensing device (not shown) and the second attachment device 24 to the detection device (not shown) can be manually established. Alternatively, the connection of the first attachment device 22 to the sample dispensing device and the second attachment device 24 to the detection device can be established automatically after the first module 4 has been inserted into the receptacle device 36.

An embodiment of a gas chromatograph 110 according to the system described herein, in particular a process temperature gradient gas chromatograph according to the system described herein, is shown in FIG. 16. Identical components of FIG. 16 are provided with identical reference signs as already mentioned above.

The gas chromatograph 110 is characterized by the device 2 according to the system described herein. In addition to the device 2 according to the system described herein, the gas chromatograph 110 includes a housing 112 and an air bath furnace 114. The air bath furnace 114 can be integrated in the housing 112. The air bath furnace 114 is used in particular to set a predefined temperature of the first attachment device 22 and the second attachment device 24. The air bath furnace 114 can be opened via a door 116. When an operator of the gas chromatograph 110 opens the door 116 of the air bath furnace 114, the operator, in the embodiment of the gas chromatograph 110 shown in FIG. 16, can remove the first module 4 orthogonally to the flow direction of the fluid flow of the fluid 12, in particular in the direction of the x axis of the Cartesian coordinate system shown in FIG. 16.

The gas chromatograph 110 furthermore includes a sample dispensing device 26 for dispensing the material 20 or material mixture 20 to be analyzed using the gas chromatograph 110. The sample dispensing device 26 is additionally used to dispense the carrier gas in the separating capillary 16.

Furthermore, the gas chromatograph 110 includes a detection device 28 for detecting a material 20 or material mixture 20 to be analyzed using the gas chromatograph 110. The sample dispensing device 26 and the detection device 28 are arranged on the gas chromatograph 110 such that the sample dispensing device 26 and the detection device 28 are also temperature controlled by the air bath furnace 114.

Furthermore, the gas chromatograph 110 includes an electronics unit 118. The electronics unit 118 includes the computing unit 34 of the device 2 according to the system described herein, a power supply of the gas chromatograph 110, and controllers which are used for the system described herein.

The embodiment of the gas chromatograph 110 shown in FIG. 16 enables a flexible removal of the first module 4 of the device 2 according to the system described herein. Of course, the gas chromatograph 110 is not restricted to the embodiment shown in FIG. 16, but can be embodied in any form which is suitable for the invention.

The features of the invention disclosed in the present description, in the drawings, and in the claims can be essential both individually and also in arbitrary combinations for the implementation of the invention in its various embodiments. The invention is not restricted to the described embodiments. It can be varied in the scope of the claims and in consideration of the knowledge of a person of relevant skill in the art.

1. A device for a gas chromatograph, comprising:
a first module;
a separating capillary, which is arranged in the first module, wherein the separating capillary is heatable, wherein the separating capillary is arrangeable in a controllable fluid flow field of a fluid, and wherein a material or a material mixture to be analyzed by the gas chromatograph can be applied to the separating capillary;
a first generating device that generates a fluid flow of the fluid, wherein the first generating device is used for influencing the temperature of the separating capillary;
an influencing device that influences the fluid flow of the fluid; and
a receptacle device that accommodates the first module, wherein the first module is insertable into the receptacle device and is removable from the receptacle device.

2. The device as claimed in claim 1, further comprising:
a second module in which the influencing device is arranged, the second module being insertable into the receptacle device and removable from the receptacle device.

3. The device as claimed in claim 2, wherein the first generating device is arranged in or on at least one of: the first module and/or the second module.

4. The device as claimed in claim 1, further comprising:
a second generating device that generates a fluid flow of the fluid.

5. The device as claimed in claim 2, further comprising:
a second generating device that generates a fluid flow of the fluid; and
a third module, arranged on the first module, wherein the second generating device is arranged in the third module.

6. The device as claimed in claim 5, wherein the third module is insertable into the receptacle device and is removable from the receptacle device.

7. The device as claimed in claim 5, wherein at least one of the modules includes at least one connecting device that connects to at least one other one of the modules.

8. The device as claimed in claim 1, wherein the first module, includes at least one of the following features:
a first attachment device that attaches the separating capillary to a sample dispensing device that injects the material to be analyzed or the material mixture to be analyzed and a carrier gas into the separating capillary; and/or
a second attachment device that attaches the separating capillary to a detection device that detects the material to be analyzed or the material mixture to be analyzed.

9. The device as claimed in claim 8, wherein at least one of the following features is provided:
the first attachment device includes at least one first insulator and/or at least one first heating device that sets a temperature such that a temperature above a temperature of the heatable separating capillary is settable at the first attachment device;
the first attachment device includes at least one first quick connecting device that connects the separating capillary to the sample dispensing device;
the second attachment device includes at least one second insulator and/or at least one second heating device that sets a temperature such that a temperature above a temperature of the heatable separating capillary is settable at the second attachment device;
the second attachment device includes at least one second quick connecting device that connects the separating capillary to the detection device.

10. The device as claimed in claim 8, wherein the first module is insertable into the receptacle device in such a way that upon insertion of the first module, a connection of this the first module to the influencing device is automatically established.

11. The device as claimed in claim 8, further comprising:
a second generating device that generates a fluid flow of the fluid, wherein the first module is insertable into the receptacle device in such a way that upon insertion of the first module, a connection of the first module to the influencing device and to the second generating device is automatically established.

12. The device as claimed in claim 8 wherein the first module is insertable into the receptacle device in such a way that upon insertion of the first module, a connection of the first module to the sample dispensing device and/or to the detection device can be manually established or is automatically established.

13. The device as claimed in claim 1, wherein the separating capillary has a spiral-shaped design.

14. The device as claimed in claim 1, wherein the influencing device is designed in such a way that the fluid has a centrally-symmetrical flow field after flowing through the influencing device.

15. The device as claimed in claim 14, wherein a flow speed of the centrally-symmetrical flow field of the fluid increases with increasing distance from a center of the flow field.

16. The device as claimed in claim 14, wherein the flow speed of the centrally-symmetrical flow field of the fluid decreases with increasing distance from a center of the flow field.

17. The device as claimed in claim 1, wherein at least one flow director device that sets a homogeneous flow direction of the fluid flow of the fluid is arranged along the separating capillary.

18. The device as claimed in claim 1, wherein at least one temperature sensor for contactless measurement of the temperature of the separating capillary is arranged on the device for a gas chromatograph.

19. The device as claimed in claim 1, wherein the fluid flow field is designed as a homogeneous or inhomogeneous fluid flow field.

20. The device as claimed in claim 1, wherein the device is a component of a gas chromatograph.

21. The device as claimed in claim 20, wherein the is a process temperature gradient gas chromatograph.

22. The device as claimed in claim 20, further comprising at least one of:
a detection device that detects the material to be analyzed or the material mixture to be analyzed; and/or;
fit a sample dispensing device that injects the material to be analyzed or the material mixture to be analyzed and a carrier gas into the separating capillary.
